(19) United States
(12) Patent Application Publication
(10) Pub. No.: US 2022/0190714 A1
(43) Pub. Date: Jun. 16, 2022

(54) Switched-Capacitor Power Conversion System and Control Method

(71) Applicant: Huawei Digital Power Technologies Co., Ltd., Shenzhen (CN)

(72) Inventors: Liming Ye, Plano, TX (US); Heping Dai, Plano, TX (US); Dianbo Fu, Frisco, TX (US)

(21) Appl. No.: 17/685,680

(22) Filed: Mar. 3, 2022

Related U.S. Application Data
(63) Continuation of application No. PCT/US2019/050499, filed on Sep. 11, 2019.

(51) Int. Cl. H02M 3/07; H02M 3/158; H02M 1/00

(52) U.S. Cl. CPC H02M 3/07; H02M 1/007; H02M 3/158

(57) ABSTRACT

A system includes a first switched-capacitor converter including a plurality of switches connected in series, a second switched-capacitor converter, and a third switched-capacitor converter connected in parallel with the second switched-capacitor converter between a common node of two switches of the plurality of switches and a load, the second switched-capacitor converter and the third switched-capacitor converter both including inductors.

### CROSS-REFERENCE TO RELATED APPLICATIONS

This application is a continuation of Application No. PCT/US2019/050499, filed on Sep. 11, 2019, which application is hereby incorporated herein by reference in its entirety.

### TECHNICAL FIELD

The present disclosure relates to a high efficiency switched-capacitor power conversion system, and, in particular embodiments, to a multi-stage switched-capacitor power conversion system.

### BACKGROUND

As technologies further advance, a variety of electronic devices, such as mobile phones, tablet PCs, digital cameras, MP3 players and/or the like, have become popular. Each electronic device requires direct current (DC) power at a substantially constant voltage which may be regulated within a specified range even when the current drawn by the electronic device may vary over a wide range. When an input voltage is lower than the specific range, a step-up DC/DC converter may be employed to convert the input voltage into a regulated voltage within the specific range. On the other hand, when the input voltage is higher than the specific range, a step-down DC/DC converter may be used to convert the voltage of the input power source into a lower voltage to satisfy the operational voltage to which the electronic circuit is specified.

There may be a variety of DC/DC conversion topologies. In accordance with the topology difference, DC/DC converters can be divided into three categories, namely, switching DC/DC converters, linear regulators and switched-capacitor converters. In accordance with the voltage level difference, DC/DC converters can be divided into two categories, namely, two-level power converters and three-level power converters. Switched-capacitor converters are one type of three-level power converters.

As integrated circuits become increasingly advanced while shrinking in size at the same time, a compact and high efficiency DC/DC conversion topology is desirable. In comparison with other topologies, switched-capacitor converters are less complicated because the switched-capacitor converters are formed by a plurality of switches and a flying capacitor. In addition, the switched-capacitor converters have a small footprint and are capable of generating a high efficient power conversion by switching the flying capacitor between a charging phase and a discharging phase. As a result, the switched-capacitor converters can provide compact and efficient power for integrated circuits.

Switched-capacitor converters are capable of eliminating large redistribution currents amongst the switched capacitors at switching moments. As a result, much smaller capacitances are needed for the switched-capacitor converters. In addition, the inductor and the flying capacitor of a switched-capacitor converter form a resonant tank. This switched-capacitor converter can also reduce switching losses through zero current switching (ZCS) and/or zero voltage switching (ZVS).

### SUMMARY

These and other problems are generally solved or circumvented, and technical advantages are generally achieved, by preferred embodiments of the present disclosure which provide a high efficiency switched-capacitor power conversion system.

In accordance with an embodiment, a system comprises a first switched-capacitor converter including a plurality of switches connected in series, a second switched-capacitor converter, and a third switched-capacitor converter connected in parallel with the second switched-capacitor converter between a common node of two switches of the plurality of switches and a load, the second switched-capacitor converter and the third switched-capacitor converter both including inductors.

The plurality of switches of the first switched-capacitor converter includes a first switch, a second switch, a third switch and a fourth switch connected in series between an input voltage bus and ground, and wherein the first switched-capacitor converter further includes a first flying capacitor connected between a common node of the first switch and the second switch, and a common node of the third switch and the fourth switch, the second switched-capacitor converter and the third switched-capacitor converter being connected in parallel between a common node of the second switch and the third switch, and the load.

The second switched-capacitor converter includes a fifth switch, a sixth switch, a seventh switch and an eighth switch connected in series between an input voltage bus and ground, and wherein the second switched-capacitor converter further includes a second flying capacitor connected between a common node of the fifth switch and the sixth switch, and a common node of the seventh switch and the eighth switch, and a first inductor connected between a common node of the sixth switch and the seventh switch, and the load.

The third switched-capacitor converter includes a ninth switch, a tenth switch, an eleventh switch and a twelfth switch connected in series between an input voltage bus and ground, and wherein the third switched-capacitor converter further includes a third flying capacitor connected between a common node of the ninth switch and the tenth switch, and a common node of the eleventh switch and the twelfth switch, and a second inductor connected between a common node of the tenth switch and the eleventh switch, and the load.

The second switched-capacitor converter includes a fifth switch, a sixth switch, a seventh switch and an eighth switch connected in series between an input voltage bus and ground, and wherein the second switched-capacitor converter further includes a second flying capacitor and a first inductor connected in series between a common node of the fifth switch and the sixth switch, and a common node of the seventh switch and the eighth switch.

The third switched-capacitor converter includes a ninth switch, a tenth switch, an eleventh switch and a twelfth switch connected in series between an input voltage bus and ground, and wherein the third switched-capacitor converter further includes a third flying capacitor and a second inductor connected in series between a common node of the ninth switch and the tenth switch, and a common node of the eleventh switch and the twelfth switch.

The second switched-capacitor converter and the third switched-capacitor converter are configured to operate at 180 degrees out of phase from one another.

Each of the first switched-capacitor converter, the second switched-capacitor converter and the third switched-capacitor converter is configured as a 2:1 step-down power converter.

Switches of the first switched-capacitor converter, the second switched-capacitor converter and the third switched-capacitor converter are configured to operate at a duty cycle of approximately 50%.

Switches of the second switched-capacitor converter and the third switched-capacitor converter are configured to operate at a duty cycle greater than or equal to 50%, and switches of the first switched-capacitor converter are configured to operate at a duty cycle less than 50%.

In accordance with another embodiment, a system comprises a plurality of switched-capacitor power conversion stages connected in cascade between a power source and a load, a first switched-capacitor power conversion stage of the plurality of switched-capacitor power conversion stages directly connected to the load, the first switched-capacitor power conversion stage including a plurality of first switched-capacitor power converters connected in parallel, each of which including an inductor, wherein a second switched-capacitor power conversion stage of the plurality of switched-capacitor power conversion stages is connected to the first switched-capacitor power conversion stage, the second switched-capacitor power conversion stage including a plurality of second switched-capacitor power converters, each of which connected to inputs of two parallel-connected first switched-capacitor power converters.

The system is a two-stage switched-capacitor power conversion system.

The second switched-capacitor power conversion stage includes a first switched-capacitor converter comprising a plurality of switches connected in series, and the first switched-capacitor power conversion stage includes a second switched-capacitor converter and a third switched-capacitor converter connected in parallel between the first switched-capacitor converter and the load.

The first switched-capacitor converter includes a first switch, a second switch, a third switch and a fourth switch connected in series between an input voltage bus and ground, and a first flying capacitor connected between a common node of the first switch and the second switch, and a common node of the third switch and the fourth switch, the second switched-capacitor converter and the third switched-capacitor converter connected in parallel between a common node of the second switch and the third switch and the load.

The second switched-capacitor converter includes a fifth switch, a sixth switch, a seventh switch and an eighth switch connected in series between the common node of the second switch and the third switch, and ground, a second flying capacitor connected between a common node of the fifth switch and the sixth switch, and a common node of the seventh switch and the eighth switch, and a first inductor connected between a common node of the sixth switch and the seventh switch and the load.

The first switched-capacitor converter includes a first switch, a second switch, a third switch and a fourth switch connected in series between an input voltage bus and ground, and a first flying capacitor connected between a common node of the first switch and the second switch, and a common node of the third switch and the fourth switch, the second switched-capacitor converter and the third switched-capacitor converter connected in parallel between a common node of the second switch and the third switch and the load.

The second switched-capacitor converter includes a fifth switch, a sixth switch, a seventh switch and an eighth switch connected in series between the common node of the second switch and the third switch, and ground, and a second flying capacitor and a first inductor connected in series between a common node of the fifth switch and the sixth switch, and a common node of the seventh switch and the eighth switch.

In accordance with yet another embodiment, a method comprises configuring a first switched-capacitor converter to operate at a first duty cycle, and configuring a second switched-capacitor converter and a third switched-capacitor converter to operate at a second duty cycle, wherein the second switched-capacitor converter and the third switched-capacitor converter are connected in parallel and operate at 180 degrees out of phase from one another.

The first switched-capacitor converter comprises a first switch, a second switch, a third switch and a fourth switch connected in series between an input voltage bus and ground, and a first flying capacitor connected between a common node of the first switch and the second switch, and a common node of the third switch and the fourth switch, the second switched-capacitor converter and the third switched-capacitor converter connected in parallel between a common node of the second switch and the third switch and a load. The second switched-capacitor converter comprises a fifth switch, a sixth switch, a seventh switch and an eighth switch connected in series between the common node of the second switch and the third switch, and ground, a second flying capacitor connected between a common node of the fifth switch and the sixth switch, and a common node of the seventh switch and the eighth switch, and a first inductor connected between a common node of the sixth switch and the seventh switch and the load.

The first switched-capacitor converter comprises a first switch, a second switch, a third switch and a fourth switch connected in series between an input voltage bus and ground, and a first flying capacitor connected between a common node of the first switch and the second switch, and a common node of the third switch and the fourth switch, the second switched-capacitor converter and the third switched-capacitor converter connected in parallel between a common node of the second switch and the third switch and a load. The second switched-capacitor converter comprises a fifth switch, a sixth switch, a seventh switch and an eighth switch connected in series between the common node of the second switch and the third switch, and ground, and a second flying capacitor and a first inductor connected in series between a common node of the fifth switch and the sixth switch, and a common node of the seventh switch and the eighth switch.

An advantage of an embodiment of the present disclosure is a high efficiency switched-capacitor power conversion system provides an efficient and reliable power conversion path between a power source and a load.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a first switched-capacitor power conversion system in accordance with various embodiments of the present disclosure;

FIG. 2 illustrates a schematic diagram of the first switched-capacitor power converter shown in FIG. 1 in accordance with various embodiments of the present disclosure;

FIG. 3 illustrates a schematic diagram of the second switched-capacitor power converter shown in FIG. 1 in accordance with various embodiments of the present disclosure;

FIG. 4 illustrates a schematic diagram of the third switched-capacitor power converter shown in FIG. 1 in accordance with various embodiments of the present disclosure;

FIG. 5 illustrates a schematic diagram of the first switched-capacitor power conversion system shown in FIG. 1 in accordance with various embodiments of the present disclosure;

FIG. 6 illustrates a gate timing diagram of the first switched-capacitor power conversion system operating in a first operating mode in accordance with various embodiments of the present disclosure;

FIG. 7 illustrates various waveforms of the first switched-capacitor power conversion system operating under the first operating mode in accordance with various embodiments of the present disclosure;

FIG. 8 illustrates a gate timing diagram of the first switched-capacitor power conversion system operating in a second operating mode in accordance with various embodiments of the present disclosure;

FIG. 9 illustrates various waveforms of the first switched-capacitor power conversion system operating in a second operating mode in accordance with various embodiments of the present disclosure;

FIG. 10 illustrates three waveforms of the first switched-capacitor power conversion system operating in a second operating mode in accordance with various embodiments of the present disclosure;

FIG. 11 illustrates another gate timing diagram of the first switched-capacitor power conversion system operating in the second operating mode in accordance with various embodiments of the present disclosure;

FIG. 12 illustrates a gate timing diagram of the first switched-capacitor power conversion system operating in a third operating mode in accordance with various embodiments of the present disclosure;

FIG. 13 illustrates another gate timing diagram of the first switched-capacitor power conversion system operating in the third operating mode in accordance with various embodiments of the present disclosure;

FIG. 14 illustrates various waveforms of the first switched-capacitor power conversion system operating in the third operating mode in accordance with various embodiments of the present disclosure;

FIG. 15 illustrates a gate timing diagram of the first switched-capacitor power conversion system operating in a fourth operating mode in accordance with various embodiments of the present disclosure;

FIG. 16 illustrates another gate timing diagram of the first switched-capacitor power conversion system operating in the fourth operating mode in accordance with various embodiments of the present disclosure;

FIG. 17 illustrates various waveforms of the first switched-capacitor power conversion system operating in the fourth operating mode in accordance with various embodiments of the present disclosure;

FIG. 18 illustrates six waveforms of the first switched-capacitor power conversion system operating in the fourth operating mode in accordance with various embodiments of the present disclosure;

FIG. 19 illustrates a block diagram of a second switched-capacitor power conversion system in accordance with various embodiments of the present disclosure;

FIG. 20 illustrates a schematic diagram of the fourth switched-capacitor power converter shown in FIG. 19 in accordance with various embodiments of the present disclosure;

FIG. 21 illustrates a schematic diagram of the fifth switched-capacitor power converter shown in FIG. 19 in accordance with various embodiments of the present disclosure;

FIG. 22 illustrates a schematic diagram of the second switched-capacitor power conversion system shown in FIG. 19 in accordance with various embodiments of the present disclosure;

FIG. 23 illustrates various waveforms of the second switched-capacitor power conversion system operating in the second operating mode in accordance with various embodiments of the present disclosure;

FIG. 24 illustrates three waveforms of the second switched-capacitor power conversion system operating in the second operating mode in accordance with various embodiments of the present disclosure;

FIG. 25 illustrates three waveforms of the second switched-capacitor power conversion system operating in the third operating mode in accordance with various embodiments of the present disclosure;

FIG. 26 illustrates a first power conversion unit of a multi-stage switched-capacitor power conversion system in accordance with various embodiments of the present disclosure;

FIG. 27 illustrates a second power conversion unit of a multi-stage switched-capacitor power conversion system in accordance with various embodiments of the present disclosure;

FIG. 28 illustrates a third power conversion unit of a multi-stage switched-capacitor power conversion system in accordance with various embodiments of the present disclosure;

FIG. 29 illustrates a first two-stage switched-capacitor power conversion system in accordance with various embodiments of the present disclosure;

FIG. 30 illustrates a second two-stage switched-capacitor power conversion system in accordance with various embodiments of the present disclosure;

FIG. 31 illustrates a first three-stage switched-capacitor power conversion system in accordance with various embodiments of the present disclosure;

FIG. 32 illustrates a second three-stage switched-capacitor power conversion system in accordance with various embodiments of the present disclosure;

FIG. 33 illustrates a first four-stage switched-capacitor power conversion system in accordance with various embodiments of the present disclosure; and

FIG. 34 illustrates a second four-stage switched-capacitor power conversion system in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely a high efficiency switched-capacitor power conversion system. The present disclosure may also be applied, however, to a variety of power conversion systems. Hereinafter, various embodiments will be explained in detail with reference to the accompanying drawings.

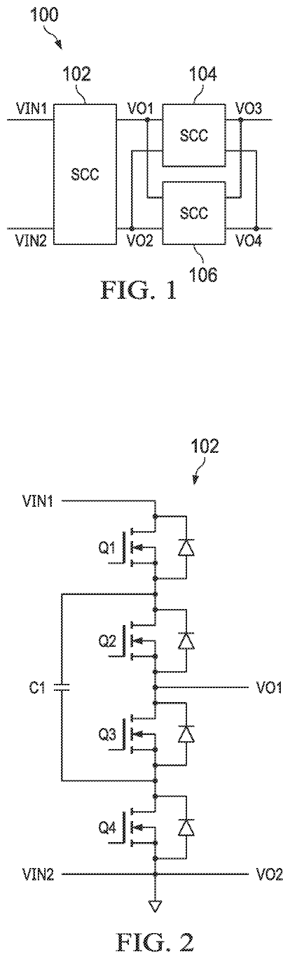

FIG. 1 illustrates a block diagram of a first switched-capacitor power conversion system in accordance with various embodiments of the present disclosure. The first switched-capacitor power conversion system 100 is a two-stage switched-capacitor power conversion system. A first stage of the first switched-capacitor power conversion system 100 is implemented as a first switched-capacitor power converter (SCC) 102. The first switched-capacitor power converter 102 has a first input terminal connected to a firs input voltage bus VIN1 and a second input terminal connected to a second input voltage bus VIN2. The first switched-capacitor power converter 102 comprises a plurality of switches connected in series between VIN1 and VIN2. The first switched-capacitor power converter 102 further comprises a first flying capacitor. The detailed structure of the first switched-capacitor power converter 102 will be described below with respect to FIG. 2.

A second stage of the first switched-capacitor power conversion system 100 comprises a second switched-capacitor power converter (SCC) 104 and a third switched-capacitor power converter (SCC) 106 connected in parallel. As shown in FIG. 1, a first input terminal of the second switched-capacitor power converter 104 is connected to a first input terminal of the third switched-capacitor power converter 106 and further connected to a first output voltage bus VO1 of the first switched-capacitor power converter 102. Likewise, a second input terminal of the second switched-capacitor power converter 104 is connected to a second input terminal of the third switched-capacitor power converter 106 and further connected to a second output voltage bus VO2 of the first switched-capacitor power converter 102.

As shown in FIG. 1, a first output terminal of the second switched-capacitor power converter 104 is connected to a first output terminal of the third switched-capacitor power converter 106 and further connected to a third output voltage bus VO3. Likewise, a second output terminal of the second switched-capacitor power converter 104 is connected to a second output terminal of the third switched-capacitor power converter 106 and further connected to a fourth output voltage bus VO4.

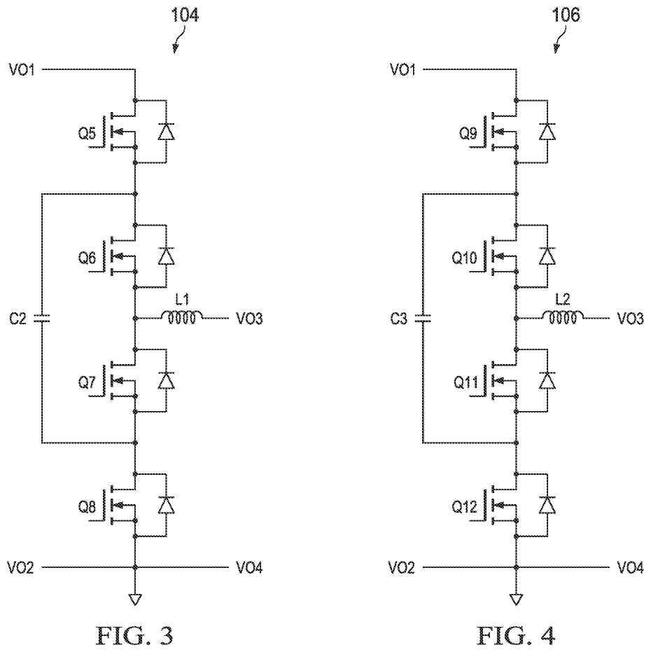

The second switched-capacitor power converter 104 comprises a plurality of switches connected in series between VO1 and VO2. The second switched-capacitor power converter 104 further comprises a second flying capacitor and a first inductor. The detailed structure of the second switched-capacitor power converter 104 will be described below with respect to FIG. 3.

The third switched-capacitor power converter 106 comprises a plurality of switches connected in series between VO1 and VO2. The third switched-capacitor power converter 106 further comprises a third flying capacitor and a second inductor. The detailed structure of the third switched-capacitor power converter 106 will be described below with respect to FIG. 4.

In some embodiments, the first switched-capacitor power converter 102 is configured as a first 2:1 power conversion apparatus. The second switched-capacitor power converter 104 is configured as a second 2:1 power conversion apparatus. The third switched-capacitor power converter 106 is configured as a third 2:1 power conversion apparatus.

In some embodiments, the first input voltage bus VIN2, the second output voltage bus VO2 and the fourth output voltage bus VO4 are connected together and further connected to ground. The first switched-capacitor power converter 102 is a 2:1 power conversion apparatus. The voltage on the first output voltage bus VO1 is equal to one half of the voltage on the first input voltage bus VIN1. Likewise, because the second switched-capacitor power converter 104 and the third switched-capacitor power converter 106 are 2:1 power conversion apparatuses, the voltage on the third output voltage bus VO3 is equal to one half of the voltage on the first output voltage bus VO1. The first switched-capacitor power conversion system 100 is a 4:1 power conversion system. In other words, the voltage on the third output voltage bus VO3 is equal to one fourth of the voltage on the first input voltage bus VIN1.

In operation, the first switched-capacitor power conversion system 100 may operate in a variety of operating modes. In a first operating mode, the first switched-capacitor power converter 102, the second switched-capacitor power converter 104 and the third switched-capacitor power converter 106 are configured to operate at a same switching frequency. The first switched-capacitor power converter 102, the second switched-capacitor power converter 104 and the third switched-capacitor power converter 106 are configured to operate at a same duty cycle. In some embodiments, the duty cycle is equal to 50%. Furthermore, the second switched-capacitor power converter 104 and the third switched-capacitor power converter 106 operate at 180 degrees out of phase from one another.

In a second operating mode, the first switched-capacitor power converter 102, the second switched-capacitor power converter 104 and the third switched-capacitor power converter 106 are configured to operate at a same switching frequency. The first switched-capacitor power converter 102 is configured to operate at a first duty cycle. The second switched-capacitor power converter 104 and the third switched-capacitor power converter 106 are configured to operate at a second duty cycle. In some embodiments, the second duty cycle is equal to 50%. The first duty cycle is less than the second duty cycle. Furthermore, the second switched-capacitor power converter 104 and the third switched-capacitor power converter 106 operate at 180 degrees out of phase from one another.

In a third operating mode, the first switched-capacitor power converter 102, the second switched-capacitor power converter 104 and the third switched-capacitor power converter 106 are configured to operate at two different switching frequencies. The first switched-capacitor power converter 102 operates at a first switching frequency. The second switched-capacitor power converter 104 and the third switched-capacitor power converter 106 operate at a second switching frequency. In some embodiments, the first switching frequency is twice the second switching frequency. The first switched-capacitor power converter 102, the second switched-capacitor power converter 104 and the third switched-capacitor power converter 106 are configured to operate at a same duty cycle. In some embodiments, the duty cycle is equal to 50%. Furthermore, the second switched-capacitor power converter 104 and the third switched-capacitor power converter 106 operate at 180 degrees out of phase from one another.

In a fourth operating mode, the first switched-capacitor power converter 102, the second switched-capacitor power converter 104 and the third switched-capacitor power converter 106 are configured to operate at two different switching frequencies. The first switched-capacitor power converter 102 operates at a first switching frequency. The second switched-capacitor power converter 104 and the third switched-capacitor power converter 106 operate at a second switching frequency. In some embodiments, the second switching frequency is three times the first switching frequency. The first switched-capacitor power converter 102, the second switched-capacitor power converter 104 and the third switched-capacitor power converter 106 are configured to operate at a same duty cycle. In some embodiments, the duty cycle is equal to 50%. Furthermore, the second switched-capacitor power converter 104 and the third switched-capacitor power converter 106 operate at 180 degrees out of phase from one another. Depending on various application and environmental variations, the phase shift between the second switched-capacitor power converter 104 and the third switched-capacitor power converter 106 under four operating modes described above may be equal to about 180 degrees. It should be appreciated that devices covered by the claims may exhibit non-ideal performance and therefore exhibit non-ideal performance characteristics. As an example, switched-capacitor converters configured to operate at approximately 180 degrees out of phase from one another may operate within an acceptable range of from about 179 degrees to about 181 degrees depending on various application and environmental variations.

It should be noted that by swapping the input port and the output port shown in FIG. 1, the first switched-capacitor power conversion system 100 can be configured as step-up switched-capacitor power conversion system.

FIG. 2 illustrates a schematic diagram of the first switched-capacitor power converter shown in FIG. 1 in accordance with various embodiments of the present disclosure. The first switched-capacitor power converter 102 comprises a first switch Q1, a second switch Q2, a third switch Q3, a fourth switch Q4 and a capacitor C1. As shown in FIG. 2, the common node of the second switch Q2 and the third switch Q3 is the first output voltage bus VO1. The second input voltage bus VIN2 and the second output voltage bus VO2 are connected together and further connected to ground.

The first switch Q1, the second switch Q2, the third switch Q3 and the fourth switch Q4 are connected in series between the first input voltage bus VIN1 and ground. In some embodiments, the capacitor C1 functions as a flying capacitor. Throughout the description, the capacitor C1 is alternatively referred to as a first flying capacitor C1.

In accordance with an embodiment, the switches (e.g., switches Q1-Q4) may be metal oxide semiconductor field-effect transistor (MOSFET) devices. Alternatively, the switching element can be any controllable switches such as insulated gate bipolar transistor (IGBT) devices, integrated gate commutated thyristor (IGCT) devices, gate turn-off thyristor (GTO) devices, silicon controlled rectifier (SCR) devices, junction gate field-effect transistor (JFET) devices, MOS controlled thyristor (MCT) devices and the like.

It should be noted while FIG. 2 shows the switches Q1-Q4 are implemented as single n-type transistors, a person skilled in the art would recognize there may be many variations, modifications and alternatives. For example, depending on different applications and design needs, the switches Q1-Q4 may be implemented as p-type transistors. Furthermore, each switch shown in FIG. 2 may be implemented as a plurality of switches connected in parallel. Moreover, a capacitor may be connected in parallel with one switch to achieve zero voltage switching (ZVS)/zero current switching (ZCS).

FIG. 3 illustrates a schematic diagram of the second switched-capacitor power converter shown in FIG. 1 in accordance with various embodiments of the present disclosure. As shown in FIG. 3, the second switched-capacitor power converter 104 comprises switches Q5, Q6, Q7 and Q8 connected in series between the first output voltage bus VO1 and ground. A second flying capacitor C2 is connected between a common node of switches Q5, Q6, and a common node of switches Q7, Q8. The second switched-capacitor power converter 104 is similar to the first switched-capacitor power converter 102 except that an inductor L1 is connected to a common node of switches Q6 and Q7 as shown in FIG. 3.

FIG. 4 illustrates a schematic diagram of the third switched-capacitor power converter shown in FIG. 1 in accordance with various embodiments of the present disclosure. As shown in FIG. 4, the third switched-capacitor power converter 106 comprises switches Q9, Q10, Q11 and Q12 connected in series between the first output voltage bus VO1 and ground. A third flying capacitor C3 is connected between a common node of switches Q9, Q10, and a common node of switches Q11, Q12. The third switched-capacitor power converter 106 is similar to the first switched-capacitor power converter 102 except that an inductor L2 is connected to a common node of switches Q10 and Q11 as shown in FIG. 4.

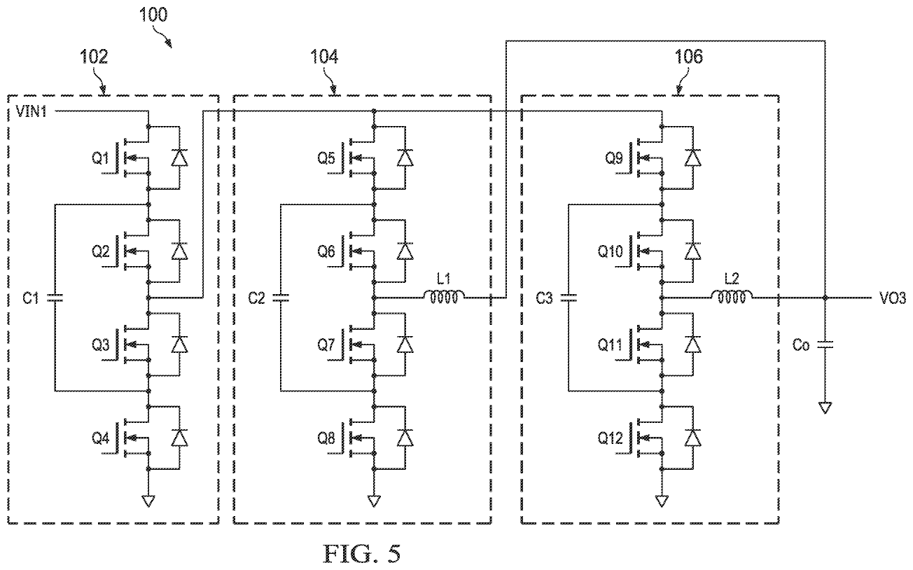

FIG. 5 illustrates a schematic diagram of the first switched-capacitor power conversion system shown in FIG. 1 in accordance with various embodiments of the present disclosure. The first switched-capacitor power conversion system 100 comprises two power conversion stages connected in cascade between the first input voltage bus VIN1 and the third output voltage bus VO3. The first power conversion stage comprises the first switched-capacitor power converter 102. The second power conversion stage comprises the second switched-capacitor power converter 104 and the third switched-capacitor power converter 106 connected in parallel between the output of the first power conversion stage and the output (VO3) of the first switched-capacitor power conversion system 100. An output capacitor Co is connected between VO3 and ground. The output capacitor Co, the inductor L1 and the inductor L2 form two output filters connected in parallel.

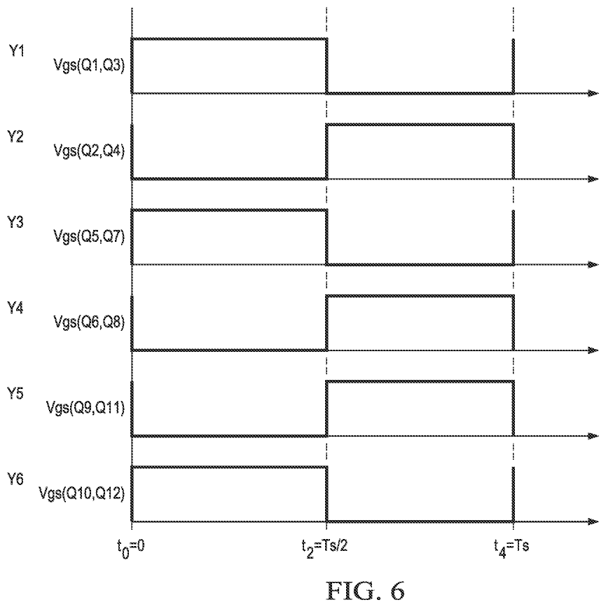

In operation, the first switched-capacitor power conversion system 100 may operate in a variety of operating modes. The control mechanisms of the variety of operating modes will be described below with respect to FIGS. 6-18.

FIG. 6 illustrates a gate timing diagram of the first switched-capacitor power conversion system operating in a first operating mode in accordance with various embodiments of the present disclosure. The horizontal axis of FIG. 6 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

One switching cycle of the first switched-capacitor power conversion system 100 can be divided into two phases as shown in FIG. 6. A first phase is from 0 to Ts/2 where Ts is the switching cycle of the first switched-capacitor power conversion system 100. A second phase is from Ts/2 to Ts.

As shown in FIG. 6, the duty cycle of switches Q1 and Q3 is equal to 50%. Likewise, switches Q2, Q4 and Q5-Q12 have a duty cycle equal to 50%. In the first switched-capacitor power converter 102, the gate drive signal of switches Q1 and Q3 is complementary to the gate drive signal of switches Q2 and Q4. Likewise, in the second switched-capacitor power converter 104, the gate drive signal of switches Q5 and Q7 is complementary to the gate drive signal of switches Q6 and Q8. In the third switched-capacitor power converter 106, the gate drive signal of switches Q9 and Q11 is complementary to the gate drive signal of switches Q10 and Q12. The gate drive signals of the second switched-capacitor power converter 104 and the gate drive signals of the third switched-capacitor power converter 106 are 180 degrees out of phase from one another as shown in FIG. 6.

Furthermore, the leading edges of the gate drive signals of Q1, Q3, the gate drive signals of Q5, Q7 and the gate drive signals of Q10, Q12 are vertically aligned from each other. Likewise, the leading edges of the gate drive signals of Q2, Q4, the gate drive signals of Q6, Q8 and the gate drive signals of Q9, Q11 are vertically aligned from each other.

During the first phase, switches Q2, Q4, Q6, Q8, Q9 and Q11 are turned off. Switches Q1, Q3, Q5, Q7, Q10 and Q12 are turned on as shown in FIG. 6. As a result of turning on switches Q1, Q3, Q5, Q7, Q10 and Q12, two conductive paths are established. A first conductive path is formed by switch Q1, the first flying capacitor C1, switch Q3, switch Q5, the second flying capacitor C2, switch Q7 and inductor L1. The input power source charges flying capacitors C1, C2 and the output VO3 through the first conductive path. In some embodiments, the capacitance of the output capacitor Co is much greater than that of the second flying capacitor C2. The resonant tank of the first conductive path is formed by the first flying capacitor C1, the second flying capacitor C2 and inductor L1 connected in series. The resonant frequency (fr1) of this resonant tank can be expressed by the following equation:

$$f r 1 = \frac{1}{2 π \sqrt{L 1 \cdot ( \frac{C 1 \cdot C 2}{C 1 + C 2} )}} \qquad ( 1 )$$

In some embodiments, the capacitance of the output capacitor Co is much greater than that of the first flying capacitor C1, and the capacitance of the first flying capacitor C1 is much greater than that of the second flying capacitor C2 (Co>>C1>>C2). Equation (1) can be simplified as:

$$fr 1 ≅ \frac{1}{2 π \sqrt{L 1 \cdot C 2}} \qquad ( 2 )$$

In the first phase, a second conductive path is formed by inductor L2, switch Q10, the third flying capacitor C3 and switch Q12. The energy stored in the third flying capacitor C3 is used to charge the output VO3 through the second conductive path. In some embodiments, the capacitance of the output capacitor Co is much greater than that of the third flying capacitor C3. The resonant tank of the second conductive path is formed by the third flying capacitor C3 and inductor L2 connected in series. The resonant frequency (fr2) of this resonant tank can be expressed by the following equation:

$$fr 2 = \frac{1}{2 π \sqrt{L 2 \cdot C 3}} \qquad ( 3 )$$

In operation, the gate drive signals of switch Q1-Q12 are symmetrical. As a result of having symmetrical gate drive signals, the voltages across the flying capacitors C1, C2 and C3 can be maintained balanced. In some embodiments, the input voltage of the first switched-capacitor power conversion system 100 is defined as Vin. The dc voltages of the flying capacitors can be expressed by the following equations:

Vdc(C1)=Vin/2 (4)

Vdc(C2)=Vin/4 (5)

Vdc(C3)=Vin/4 (6)

In the second phase, switches Q1, Q3, Q5, Q7, Q10 and Q12 are turned off. Switches Q2, Q4, Q6, Q8, Q9 and Q11 are turned on as shown in FIG. 6. As a result of turning on switches Q2, Q4, Q6, Q8, Q9 and Q11, two conductive paths are established. A first conductive path is formed by switch Q4, the first flying capacitor C1, switch Q2, switch Q9, the third flying capacitor C3, switch Q11 and inductor L2. The energy stored in the first flying capacitor C1 is released to charge the third flying capacitor C3 and the output VO3 through the first conductive path. In some embodiments, the capacitance of the output capacitor Co is much greater than that of the third flying capacitor C3. The resonant tank of the second conductive path is formed by the first flying capacitor C1, the third flying capacitor C3 and inductor L2 connected in series. The resonant frequency (fr3) of this resonant tank can be expressed by the following equation:

$$fr 3 = \frac{1}{2 π \sqrt{L 2 \cdot ( \frac{C 1 \cdot C 3}{C 1 + C 3} )}} \qquad ( 7 )$$

In some embodiments, the capacitance of the output capacitor Co is much greater than that of the first flying capacitor C1, and the capacitance of the first flying capacitor C1 is much greater than that of the third flying capacitor C3 (Co>>C1>>C3). Equation (7) can be simplified as:

$$fr 3 ≅ \frac{1}{2 π \sqrt{L 2 \cdot C 3}} \qquad ( 8 )$$

In the second phase, a second conductive path is formed by inductor L1, switch Q6, the second flying capacitor C2 and switch Q8. The energy stored in the second flying capacitor C2 is used to charge the output VO3 through the second conductive path. In some embodiments, the capacitance of the output capacitor Co is much greater than that of the second flying capacitor C2. The resonant tank of the second conductive path is formed by the second flying capacitor C2 and inductor L1 connected in series. The resonant frequency (fr4) of this resonant tank can be expressed by the following equation:

$$fr 4 = \frac{1}{2 π \sqrt{L 1 \cdot C 2}} \qquad ( 9 )$$

The resonant frequencies of the first switched-capacitor power conversion system 100 can be summarized as:

$$\begin{matrix}fr 1 ≅ \frac{1}{2 π \sqrt{L 1 \cdot C 2}} & ( 10 ) \\ fr 2 = \frac{1}{2 π \sqrt{L 2 \cdot C 3}} & ( 11 ) \\ fr 3 ≅ \frac{1}{2 π \sqrt{L 2 \cdot C 3}} & ( 12 ) \\ fr 4 = \frac{1}{2 π \sqrt{L 1 \cdot C 2}} & ( 13 )\end{matrix}$$

In some embodiments, the first switched-capacitor power conversion system 100 is designed such that the second switched-capacitor power converter 104 and the third switched-capacitor power converter 106 have the same design parameters. For example, the inductance of the inductor L1 is equal to the inductance of the inductor L2. The capacitance of the second flying capacitor C2 is equal to the capacitance of the third flying capacitor C3. The four resonant frequencies above can satisfy the following relationship:

$$fr 1 = fr 2 = fr 3 = fr 4 = \frac{1}{2 π \sqrt{L 1 \cdot C 2}} \qquad ( 14 )$$

In order to achieve zero voltage switching, both stages of the first switched-capacitor power conversion system 100 operate at a switching frequency equal to the resonant frequency (fr) shown in Equation (14). The switching frequency can be given by the following equation:

$$fs = f r = \frac{1}{2 π \sqrt{L 1 \cdot C 2}} \qquad ( 15 )$$

The switching period of the first switched-capacitor power conversion system 100 can be expressed as:

Ts=2π\sqrt{L1·C2} (16)

As shown in FIG. 6, the switching period of the first switched-capacitor power conversion system 100 is equal to Ts, which is given in Equation (16). All the switches operate at 50% duty cycle.

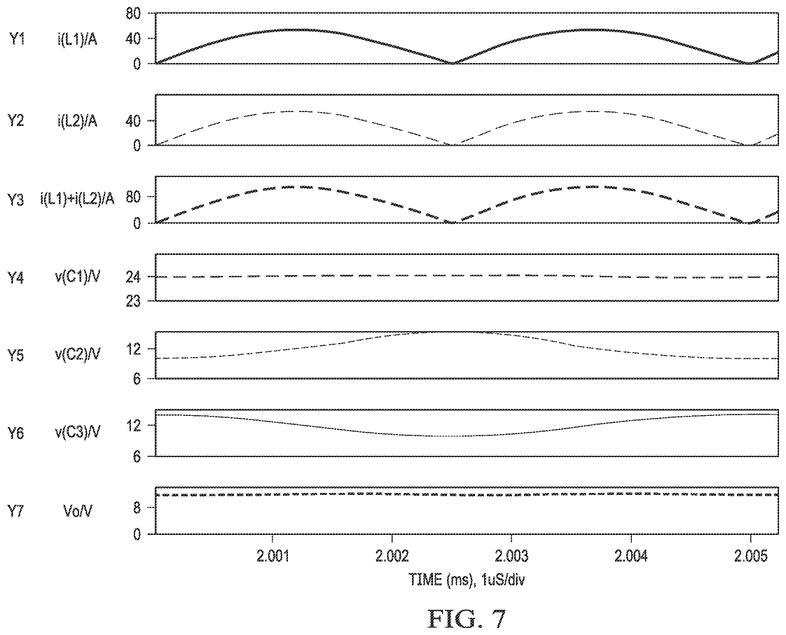

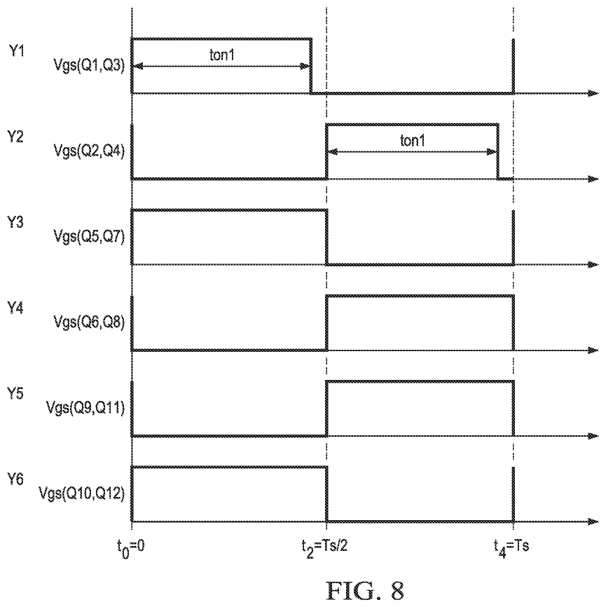

FIG. 7 illustrates various waveforms of the first switched-capacitor power conversion system operating under the first operating mode in accordance with various embodiments of the present disclosure. The horizontal axis of FIG. 7 represents intervals of time. There are seven vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The four vertical axis Y4 represents the voltage across the first flying capacitor C1. The fifth vertical axis Y5 represents the voltage across the second flying capacitor C2. The sixth vertical axis Y6 represents the voltage across the third flying capacitor C3. The seventh vertical axis Y7 represents the output voltage of the first switched-capacitor power conversion system.

The waveforms shown in FIG. 7 are obtained under the following operating conditions. The input voltage of the first switched-capacitor power conversion system 100 is equal to 48 V. The output voltage of the first switched-capacitor power conversion system 100 is equal to 12 V. The output power of the first switched-capacitor power conversion system 100 is equal to 800 W. The switching frequency of the first switched-capacitor power conversion system 100 is equal to 200 KHz. The capacitance of the first flying capacitor C1 is equal to 1 mF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

FIG. 8 illustrates a gate timing diagram of the first switched-capacitor power conversion system operating in a second operating mode in accordance with various embodiments of the present disclosure. The horizontal axis of FIG. 8 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

One switching cycle of the first switched-capacitor power conversion system 100 can be divided into two phases as shown in FIG. 8. A first phase is from 0 to Ts/2. A second phase is from Ts/2 to Ts.

As shown in FIG. 8, the duty cycle of switches Q1, Q2, Q3 and Q4 is less than 50%. Switches Q5-Q12 have a duty cycle equal to 50%. In the first switched-capacitor power converter 102, there is a delay between the falling edge of the gate drive signal of switches Q1 and Q3 and the rising edge of the gate drive signal of switches Q2 and Q4. In the second switched-capacitor power converter 104, the gate drive signal of switches Q5 and Q7 is complementary to the gate drive signal of switches Q6 and Q8. Likewise, in the third switched-capacitor power converter 106, the gate drive signal of switches Q9 and Q11 is complementary to the gate drive signal of switches Q10 and Q12. The gate drive signals of the second switched-capacitor power converter 104 and the gate drive signals of the third switched-capacitor power converter 106 are 180 degrees out of phase from one another as shown in FIG. 8.

In some embodiments, the capacitance of the first flying capacitor C1 cannot satisfy the relationships (C1>>C3 and C1>>C2) described above with respect to FIG. 6. If the capacitance of the first flying capacitor C1 is only about two or three times greater than the capacitance of the second flying capacitor C2 and/or the capacitance of the third flying capacitor C3, the resonant frequencies of the first switched-capacitor power conversion system 100 can be expressed as:

$$\begin{matrix}fr 1 = \frac{1}{2 π \sqrt{L 1 \cdot ( \frac{C 1 \cdot C 2}{C 1 + C 2} )}} & ( 17 ) \\ fr 2 = \frac{1}{2 π \sqrt{L 2 \cdot C 3}} & ( 18 ) \\ fr 3 = \frac{1}{2 π \sqrt{L 2 \cdot ( \frac{C 1 \cdot C 3}{C 1 + C 3} )}} & ( 19 ) \\ fr 4 = \frac{1}{2 π \sqrt{L 1 \cdot C 2}} & ( 20 )\end{matrix}$$

As shown in Equations (17-20), the resonant frequencies of fr1 and fr3 are greater than the resonant frequencies of fr2 and fr4. In order to compensate the mismatch between the resonant frequencies (e.g., fr1 and fr2), the turn-on time of switches Q1, Q2, Q3 and Q4 is reduced as shown in the gate drive timing diagram of FIG. 8. The turn-on time of switches Q1, Q2, Q3 and Q4 can be expressed as:

$$ton 1 = π \sqrt{L 1 \cdot ( \frac{C 1 \cdot C 2}{C 1 + C 2} )} \qquad ( 21 )$$

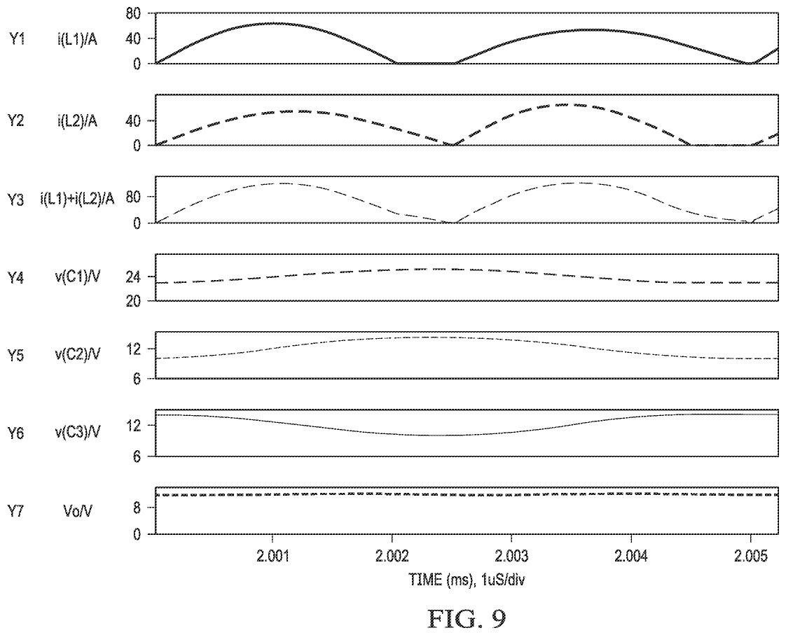

FIG. 9 illustrates various waveforms of the first switched-capacitor power conversion system operating in a second operating mode in accordance with various embodiments of the present disclosure. The horizontal axis of FIG. 9 represents intervals of time. There are seven vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The four vertical axis Y4 represents the voltage across the first flying capacitor C1. The fifth vertical axis Y5 represents the voltage across the second flying capacitor C2. The sixth vertical axis Y6 represents the voltage across the third flying capacitor C3. The seventh vertical axis Y7 represents the output voltage of the first switched-capacitor power conversion system.

The waveforms shown in FIG. 9 are obtained under the following operating conditions. The input voltage of the first switched-capacitor power conversion system 100 is equal to 48 V. The output voltage of the first switched-capacitor power conversion system 100 is equal to 12 V. The output power of the first switched-capacitor power conversion system 100 is equal to 800 W. The switching frequency of the first switched-capacitor power conversion system 100 is equal to 200 KHz. The capacitance of the first flying capacitor C1 is equal to 40 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

As shown in FIG. 9, the current flowing through the inductor L1 has a flat portion. This flat portion is generated through applying a reduced duty cycle to the first switching-capacitor power converter 102 as shown in FIG. 8. Such a flat portion helps to prevent the current from having a negative value, thereby improving the efficiency of the first switched-capacitor power conversion system 100.

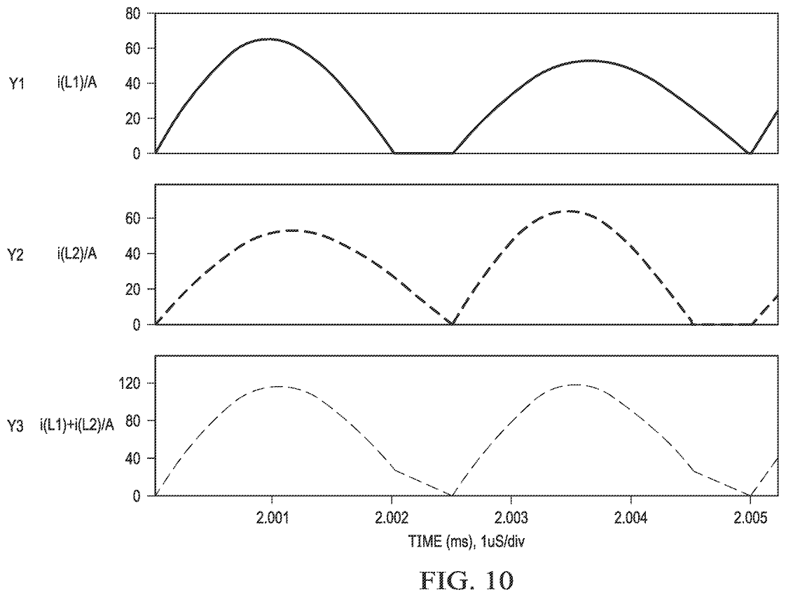

FIG. 10 illustrates three waveforms of the first switched-capacitor power conversion system operating in a second operating mode in accordance with various embodiments of the present disclosure. The horizontal axis of FIG. 10 represents intervals of time. There are three vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The waveforms shown in FIG. 10 are similar to those shown in FIG. 9, and hence are not discussed in further detail herein.

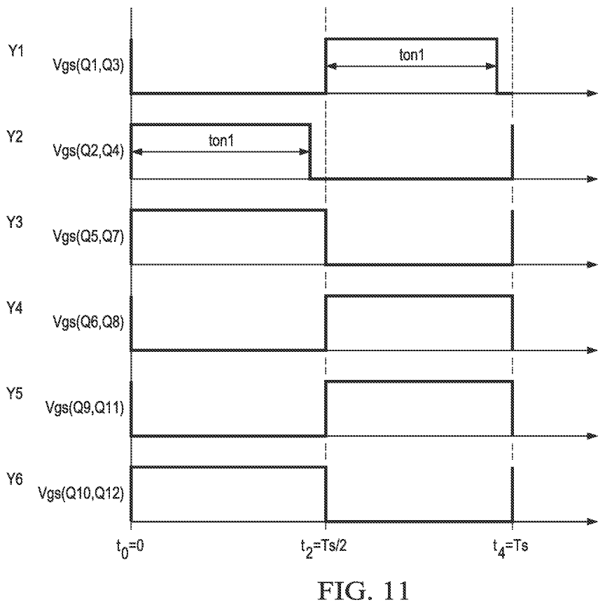

FIG. 11 illustrates another gate timing diagram of the first switched-capacitor power conversion system operating in the second operating mode in accordance with various embodiments of the present disclosure. The horizontal axis of FIG. 11 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

Due to the circuit symmetry of the first switched-capacitor power conversion system 100, the gate drive signals of the first stage can be shifted by Ts/2 in the time domain (180 degrees in phase) as shown in FIG. 11. The operating principle of the gate timing diagram shown in FIG. 11 is similar to that shown in FIG. 8, and hence is not discussed in detail herein.

Referring to FIG. 5, the first switched-capacitor power conversion system 100 comprises two stages. The first stage comprises the first switched-capacitor power converter 102. The second stage comprises the second switched-capacitor power converter 104 and the third switched-capacitor power converter 106 connected in parallel between an output of the first switched-capacitor power converter 102 and a load (not shown).

Under the operating modes shown in FIGS. 6 and 8, the first stage is configured as a 2:1 step-down power converter. The second switched-capacitor power converter 104 and the third switched-capacitor power converter 106 are connected in parallel. Each power converter of the second stage is configured as a 2:1 step-down power converter. Since the first stage and the second stage are connected in cascade, the first switched-capacitor power conversion system 100 is a 4:1 step-down power system. The second switched-capacitor power converter 104 and the third switched-capacitor power converter 106 have identical components, but operate at 180 degrees out of phase from one another. Furthermore, the first switched-capacitor power converter 102, the second switched-capacitor power converter 104 and the third switched-capacitor power converter 106 operate at a same switching frequency, which is at or near the resonant frequencies fr1-fr4 shown above.

In some embodiments, the first switched-capacitor power converter 102 distributes the power evenly to the second switched-capacitor power converter 104 and the third switched-capacitor power converter 106. Each power converter of the second stage processes one half of the power from the first switched-capacitor power converter 102. As shown in FIG. 5, it is not necessary to place a bulky intermediate bus capacitor between the first stage and the second stage. This is one advantage of having the first switched-capacitor power conversion system 100 shown in FIG. 5. The charging and discharging currents of the switched capacitors (e.g., flying capacitors C2 and C3) are limited by the inductors, thereby reducing the losses associated with the switched capacitor charge redistribution, and thus improving the efficiency of the first switched-capacitor power conversion system 100.

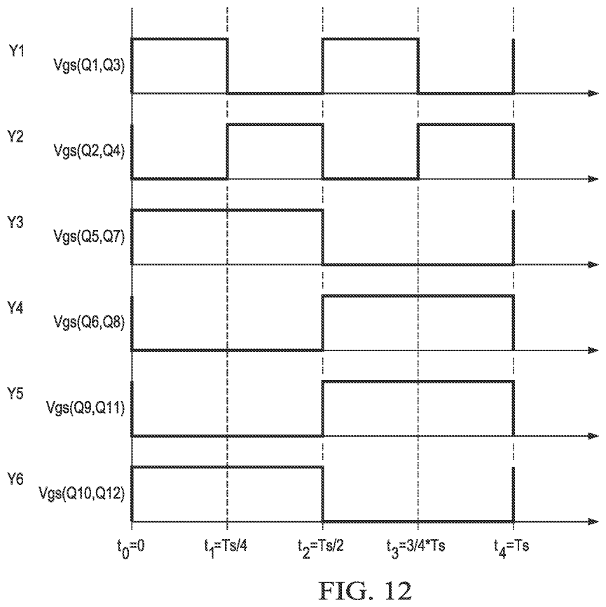

FIG. 12 illustrates a gate timing diagram of the first switched-capacitor power conversion system operating in a third operating mode in accordance with various embodiments of the present disclosure. The horizontal axis of FIG. 12 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

The third operating mode shown in FIG. 12 is similar to the first operating mode shown in FIG. 6 except that in FIG. 12, the first stage and the second stage operate at two different switching frequencies. More particularly, the switching frequency of the first stage (switches Q1-Q4) is twice the switching frequency of the second stage (switches Q5-Q12).

In some embodiments, the capacitance of the output capacitor Co is much greater than that of the second flying capacitor C2 and the third flying capacitor C3. The resonant frequencies can be expressed by the following equations:

$$\begin{matrix}fr 1 = \frac{1}{2 π \sqrt{L 1 \cdot ( \frac{C 1 \cdot C 2}{C 1 + C 2} )}} & ( 22 ) \\ fr 2 = \frac{1}{2 π \sqrt{L 2 \cdot C 3}} & ( 23 ) \\ fr 3 = \frac{1}{2 π \sqrt{L 2 \cdot ( \frac{C 1 \cdot C 3}{C 1 + C 3} )}} & ( 24 ) \\ fr 4 = \frac{1}{2 π \sqrt{L 1 \cdot C 2}} & ( 25 )\end{matrix}$$

In some embodiments, the inductance of L1 is equal to the inductance of L2. The capacitance of the second flying capacitor C2 is equal to the capacitance of the third flying capacitor C3. The capacitance of the first flying capacitor C1 is equal to one third of the capacitance of the third flying capacitor C3. The four resonant frequencies above can satisfy the following relationship:

fr1=fr3=2×fr2=2×fr4 (25)

In operation, the first switched-capacitor power converter 102 operates at a switching frequency equal to fr1 and fr3. The second switched-capacitor power converter 104 and the third switched-capacitor power converter 106 operate at a switching frequency equal to fr2 and fr4. In other words, the switching frequency of the first switched-capacitor power converter 102 is twice the switching frequency of the second switched-capacitor power converter 104 and the third switched-capacitor power converter 106.

One advantageous feature of having two stages operating at two different switching frequencies is that the capacitance of the first flying capacitor C1 can be much smaller, thereby reducing the cost of the first switched-capacitor power conversion system.

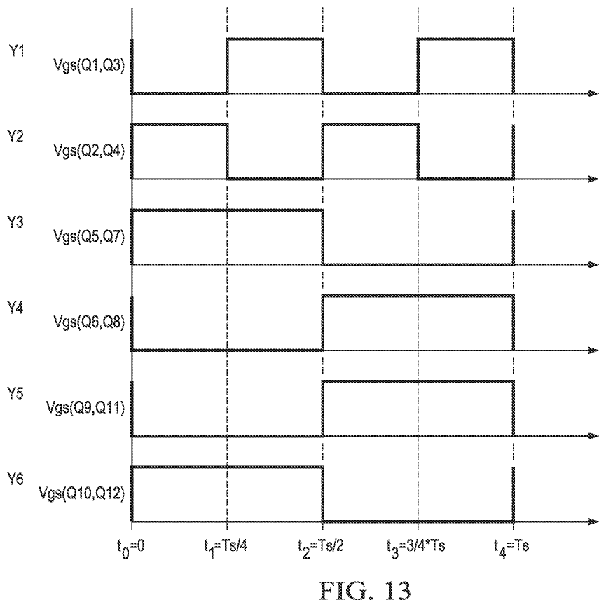

FIG. 13 illustrates another gate timing diagram of the first switched-capacitor power conversion system operating in the third operating mode in accordance with various embodiments of the present disclosure. The horizontal axis of FIG. 13 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

Due to the circuit symmetry of the first switched-capacitor power conversion system 100, the gate drive signals of the first stage can be shifted by Ts/4 in the time domain (180 degrees in phase) as shown in FIG. 13. The operating principle of the gate timing diagram shown in FIG. 13 is similar to that shown in FIG. 12, and hence is not discussed in detail herein.

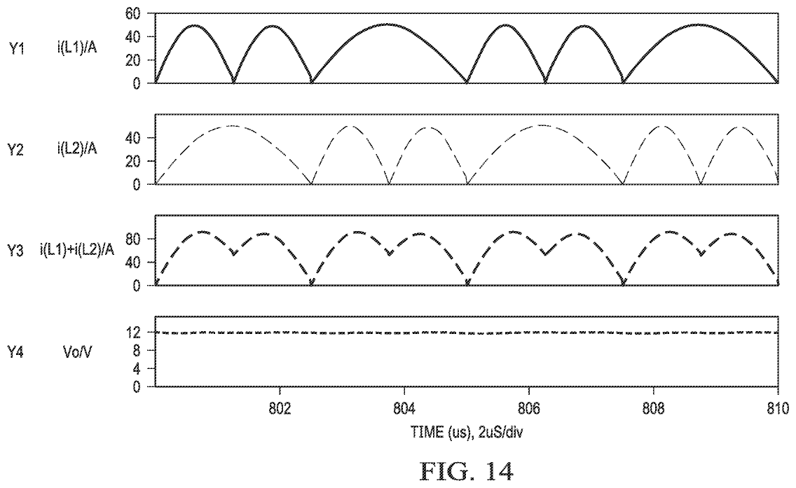

FIG. 14 illustrates various waveforms of the first switched-capacitor power conversion system operating in the third operating mode in accordance with various embodiments of the present disclosure. The horizontal axis of FIG. 14 represents intervals of time. There are four vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The four vertical axis Y4 the output voltage of the first switched-capacitor power conversion system.

The waveforms shown in FIG. 14 are obtained under the following operating conditions. The input voltage of the first switched-capacitor power conversion system 100 is equal to 48 V. The output voltage of the first switched-capacitor power conversion system 100 is equal to 12 V. The output power of the first switched-capacitor power conversion system 100 is equal to 800 W. The switching frequency of the first switched-capacitor power converter 102 is equal to 400 KHz. The switching frequency of the second switched-capacitor power converter 104 and the third switched-capacitor power converter 106 is equal to 200 KHz. The capacitance of the first flying capacitor C1 is equal to 6.8 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

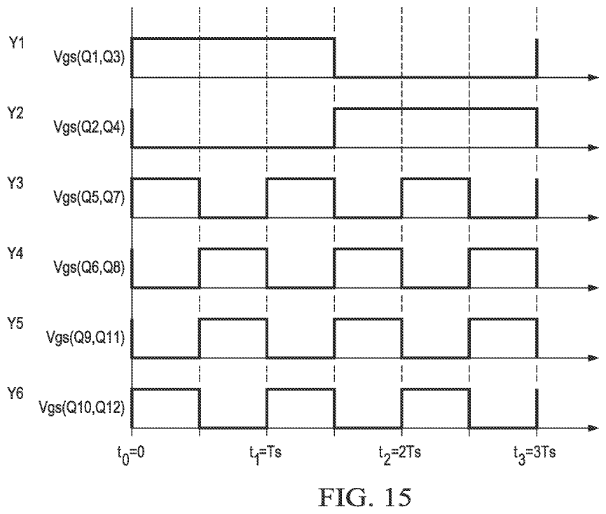

FIG. 15 illustrates a gate timing diagram of the first switched-capacitor power conversion system operating in a fourth operating mode in accordance with various embodiments of the present disclosure. The horizontal axis of FIG. 15 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

The fourth operating mode shown in FIG. 15 is similar to the first operating mode shown in FIG. 6 except that in FIG. 15, the first stage and the second stage operate at two different switching frequencies. More particularly, the switching frequency of the second stage is equal to three times the switching frequency of the first stage.

In some embodiments, the capacitance of the output capacitor Co is much greater than that of the second flying capacitor C2 and the third flying capacitor C3. Likewise, the capacitance of the first flying capacitor C1 is much greater than that of the second flying capacitor C2 and the third flying capacitor C3. The resonant frequencies can be expressed by the following equations:

$$\begin{matrix}fr 1 ≅ \frac{1}{2 π \sqrt{L 1 \cdot C 2}} & ( 26 ) \\ fr 2 = \frac{1}{2 π \sqrt{L 2 \cdot C 3}} & ( 27 ) \\ fr 3 ≅ \frac{1}{2 π \sqrt{L 2 \cdot C 3}} & ( 28 ) \\ fr 4 = \frac{1}{2 π \sqrt{L 1 \cdot C 2}} & ( 29 )\end{matrix}$$

In some embodiments, the inductance of L1 is equal to the inductance of L2. The capacitance of the second flying capacitor C2 is equal to the capacitance of the third flying capacitor C3. The four resonant frequencies above can satisfy the following relationship:

$$fr 1 = fr 2 = fr 3 = fr 4 = \frac{1}{2 π \sqrt{L 1 \cdot C 2}} \qquad ( 30 )$$

The switching frequency (fs) of the second stage is selected as:

$$fs ≅ \frac{1}{2 π \sqrt{L 1 \cdot C 2}} \qquad ( 31 )$$

In addition, the capacitance of the first flying capacitor C1 should be much greater than that of C2 and C3 so as to keep the AC voltage ripple on the first flying capacitor C1 as small as possible, and thus keep the amplitude envelopes of the inductor currents reasonably smooth.

It should be noted while FIG. 15 shows the switching frequency of the first stage is equal to one third of the switching frequency of the second stage, this is merely an example. Depending on different applications and design needs, the switching frequency of the first stage can be set at fs, fs/3, fs/5 . . . fs/N . . . where N is an odd number and fs is the switching frequency of the second stage. One advantageous feature of setting N as an odd number is the current can be evenly distributed between inductors L1 and L2 without having a large first flying capacitor C1.

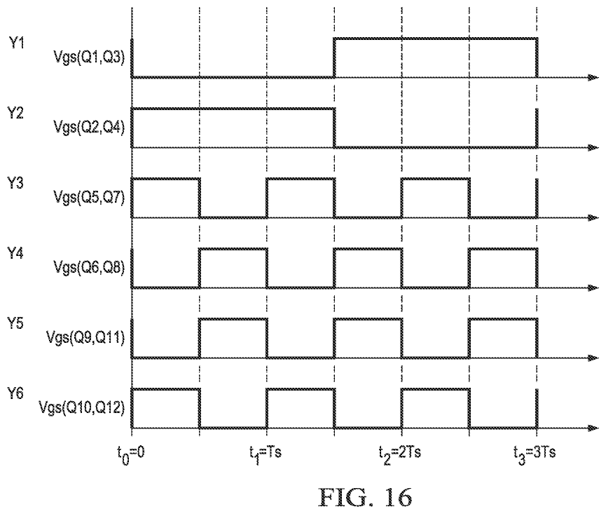

FIG. 16 illustrates another gate timing diagram of the first switched-capacitor power conversion system operating in the fourth operating mode in accordance with various embodiments of the present disclosure. The horizontal axis of FIG. 16 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the gate drive signals of switches Q5 and Q7. The four vertical axis Y4 represents the gate drive signals of switches Q6 and Q8. The fifth vertical axis Y5 represents the gate drive signals of switches Q9 and Q11. The sixth vertical axis Y6 represents the gate drive signals of switches Q10 and Q12.

Due to the circuit symmetry of the first switched-capacitor power conversion system 100, the gate drive signals of the first stage can be shifted by 1.5×Ts in the time domain (180 degrees in phase) as shown in FIG. 15. The operating principle of the gate timing diagram shown in FIG. 15 is similar to that shown in FIG. 14, and hence is not discussed in detail herein.

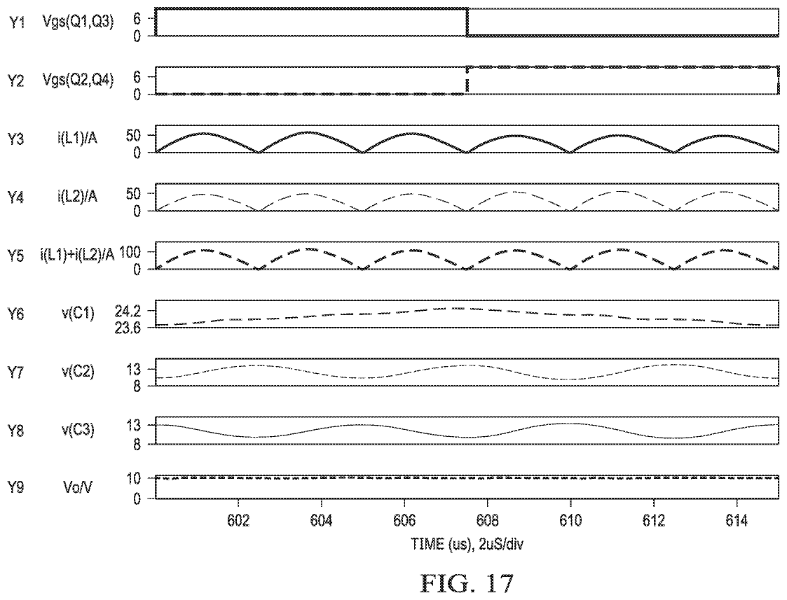

FIG. 17 illustrates various waveforms of the first switched-capacitor power conversion system operating in the fourth operating mode in accordance with various embodiments of the present disclosure. The horizontal axis of FIG. 17 represents intervals of time. There are nine vertical axes. The first vertical axis Y1 represents the gate drive signals of switches Q1 and Q3. The second vertical axis Y2 represents the gate drive signals of switches Q2 and Q4. The third vertical axis Y3 represents the current flowing through the inductor L1. The fourth vertical axis Y4 represents the current flowing through the inductor L2. The fifth vertical axis Y5 represents the sum of the current flowing through the inductor L1 and the current flowing through the inductor L2. The sixth vertical axis Y6 represents the voltage across the first flying capacitor C1. The seventh vertical axis Y7 represents the voltage across the second flying capacitor C2. The eighth vertical axis Y8 represents the voltage across the third flying capacitor C3. The ninth vertical axis Y9 represents the output voltage of the first switched-capacitor power conversion system.

The waveforms shown in FIG. 17 are obtained under the following operating conditions. The input voltage of the first switched-capacitor power conversion system 100 is equal to 48 V. The output voltage of the first switched-capacitor power conversion system 100 is equal to 12 V. The output power of the first switched-capacitor power conversion system 100 is equal to 800 W. The switching frequency of the first switched-capacitor power converter 102 is equal to 66.7 KHz. The switching frequency of the second switched-capacitor power converter 104 and the third switched-capacitor power converter 106 is equal to 200 KHz. The capacitance of the first flying capacitor C1 is equal to 400 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

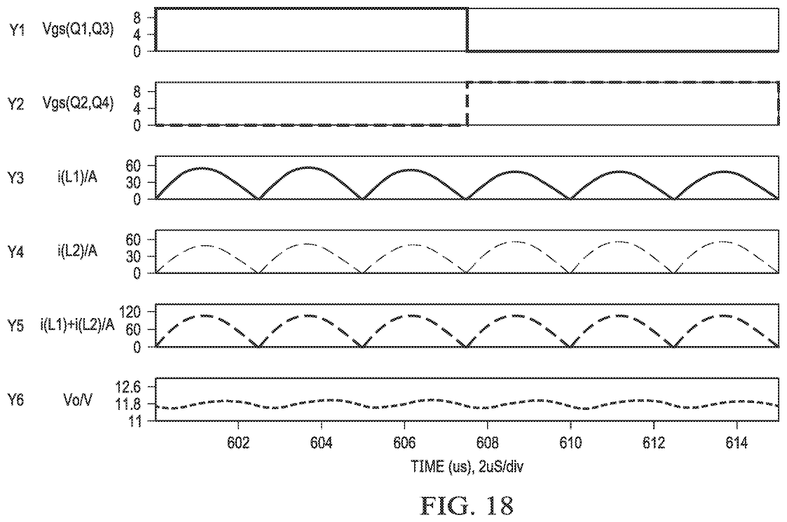

FIG. 18 illustrates six waveforms of the first switched-capacitor power conversion system operating in the fourth operating mode in accordance with various embodiments of the present disclosure. The horizontal axis of FIG. 18 represents intervals of time. There are six vertical axes. The first vertical axis Y1 represents the gate drive signals of switches Q1 and Q3. The second vertical axis Y2 represents the gate drive signals of switches Q2 and Q4. The third vertical axis Y3 represents the current flowing through the inductor L1. The fourth vertical axis Y4 represents the current flowing through the inductor L2. The fifth vertical axis Y5 represents the sum of the current flowing through the inductor L1 and the current flowing through the inductor L2. The sixth vertical axis Y6 represents the output voltage of the first switched-capacitor power conversion system.

The waveforms shown in FIG. 18 are obtained under the following operating conditions. The input voltage of the first switched-capacitor power conversion system 100 is equal to 48 V. The output voltage of the first switched-capacitor power conversion system 100 is equal to 12 V. The output power of the first switched-capacitor power conversion system 100 is equal to 800 W. The switching frequency of the first switched-capacitor power converter 102 is equal to 66.7 KHz. The switching frequency of the second switched-capacitor power converter 104 and the third switched-capacitor power converter 106 is equal to 200 KHz. The capacitance of the first flying capacitor C1 is equal to 400 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

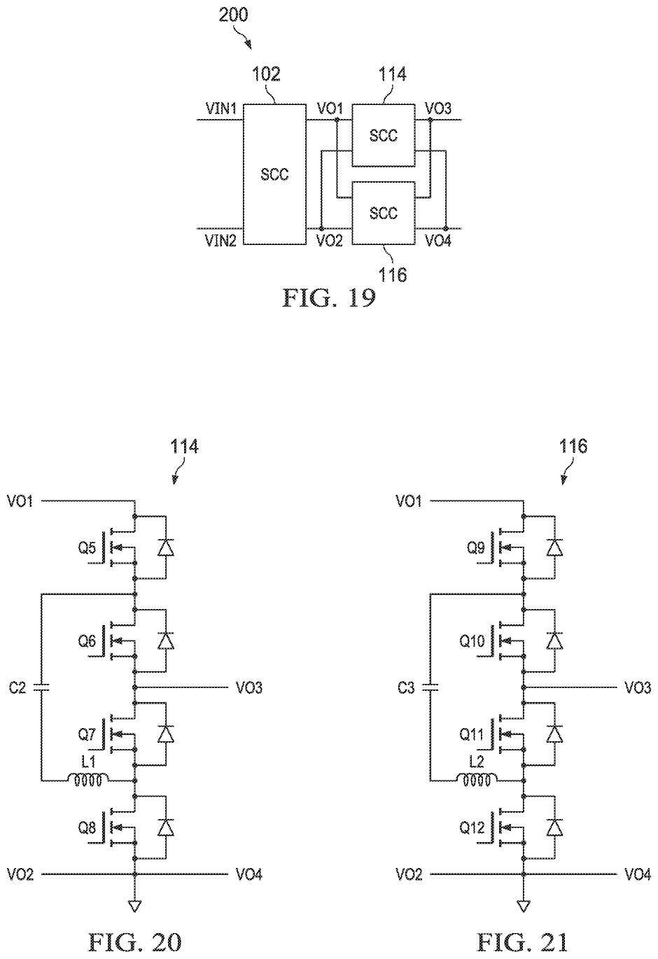

FIG. 19 illustrates a block diagram of a second switched-capacitor power conversion system in accordance with various embodiments of the present disclosure. The second switched-capacitor power conversion system 200 shown in FIG. 19 is similar to the first switched-capacitor power conversion system 100 shown in FIG. 1 except the second stage is formed by different switched-capacitor power converters. As shown in FIG. 19, the second stage comprises a fourth switched-capacitor power converter 114 and a fifth switched-capacitor power converter 116 connected in parallel. The detailed structure of the fourth switched-capacitor power converter 114 and the fifth switched-capacitor power converter 116 will be described below with respect to FIGS. 20 and 21, respectively.

The second switched-capacitor power conversion system 200 is configured as a step-down power conversion system when an input power source is connected to inputs of the first switched-capacitor power converter, and a load is connected to the outputs of the fourth switched-capacitor power converter 114 and a fifth switched-capacitor power converter 116. It should be noted that by swapping the input port and the output port shown in FIG. 19, the second switched-capacitor power conversion system 200 can be configured as step-up switched-capacitor power conversion system.

FIG. 20 illustrates a schematic diagram of the fourth switched-capacitor power converter shown in FIG. 19 in accordance with various embodiments of the present disclosure. The fourth switched-capacitor power converter 114 shown in FIG. 20 is similar to the second switched-capacitor power converter 104 shown in FIG. 3 except that the inductor L1 and the second flying capacitor C2 are connected in series between a common node of switches Q5, Q6, and a common node of switches Q7, Q8. The inductor L1 and the second flying capacitor C2 form a resonant tank for the fourth switched-capacitor power converter 114.

FIG. 21 illustrates a schematic diagram of the fifth switched-capacitor power converter shown in FIG. 19 in accordance with various embodiments of the present disclosure. The fifth switched-capacitor power converter 116 shown in FIG. 21 is similar to the third switched-capacitor power converter 106 shown in FIG. 4 except that the inductor L2 and the third flying capacitor C3 are connected in series between a common node of switches Q9, Q10, and a common node of switches Q11, Q12. The inductor L2 and the third flying capacitor C3 form a resonant tank for the fifth switched-capacitor power converter 116.

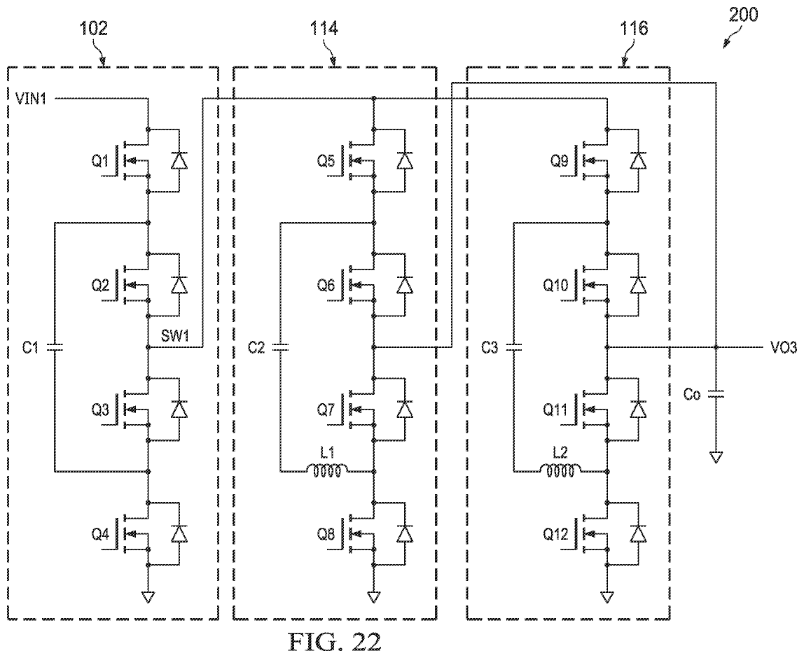

FIG. 22 illustrates a schematic diagram of the second switched-capacitor power conversion system shown in FIG. 19 in accordance with various embodiments of the present disclosure. The second switched-capacitor power conversion system 200 comprises two power conversion stages connected in cascade between the first input voltage bus VIN1 and the third output voltage bus VO3. The first power conversion stage comprises the first switched-capacitor power converter 102. The second power conversion stage comprises the fourth switched-capacitor power converter 114 and the fifth switched-capacitor power converter 116 connected in parallel between the output of the first power conversion stage and the output (VO3) of the second switched-capacitor power conversion system 200. An output capacitor Co is connected between VO3 and ground. The output capacitor Co, the inductor L1 and the inductor L2 form two output filters connected in parallel.

In operation, the operating modes and the associated control mechanisms described above with respect to the first switched-capacitor power conversion system 100 are also applicable to the second switched-capacitor power conversion system 200 shown in FIG. 22.

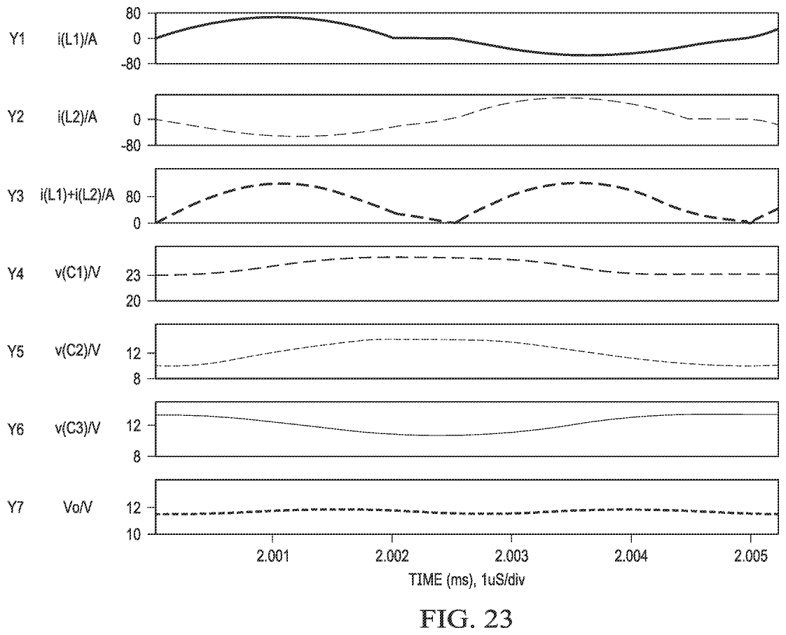

FIG. 23 illustrates various waveforms of the second switched-capacitor power conversion system operating in the second operating mode in accordance with various embodiments of the present disclosure. The horizontal axis of FIG. 23 represents intervals of time. There are seven vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The four vertical axis Y4 represents the voltage across the first flying capacitor C1. The fifth vertical axis Y5 represents the voltage across the second flying capacitor C2. The sixth vertical axis Y6 represents the voltage across the third flying capacitor C3. The seventh vertical axis Y7 represents the output voltage of the second switched-capacitor power conversion system.

The waveforms shown in FIG. 23 are obtained under the following operating conditions. The input voltage of the second switched-capacitor power conversion system 200 is equal to 48 V. The output voltage of the second switched-capacitor power conversion system 200 is equal to 12 V. The output power of the second switched-capacitor power conversion system 200 is equal to 800 W. The switching frequency of the second switched-capacitor power conversion system 200 is equal to 200 KHz. The capacitance of the first flying capacitor C1 is equal to 40 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

As shown in FIG. 23, the current flowing through the inductor L1 has a flat portion. This flat portion is generated through applying a reduced duty cycle to the first switching-capacitor power converter 102 (reduced duty cycle shown in FIG. 8). Such a flat portion helps to prevent the current from having a negative value, thereby improving the efficiency of the second switched-capacitor power conversion system 200.

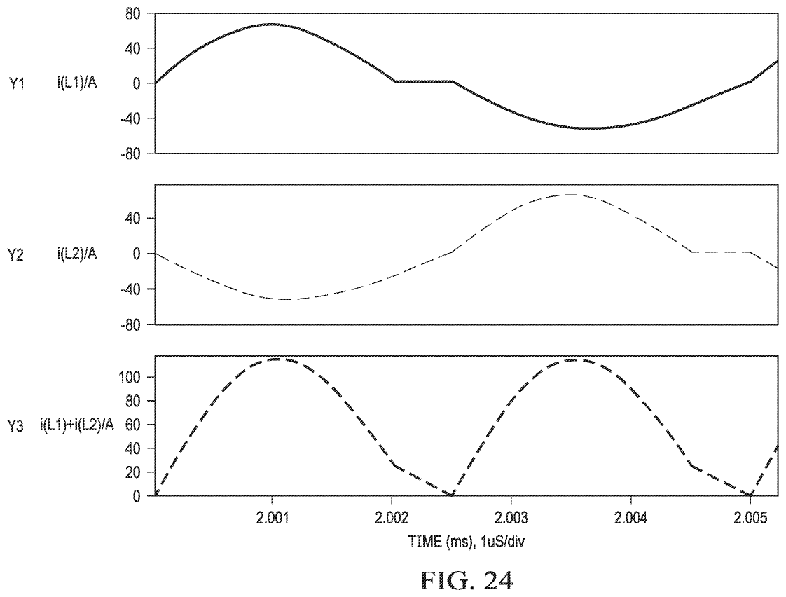

FIG. 24 illustrates three waveforms of the second switched-capacitor power conversion system operating in the second operating mode in accordance with various embodiments of the present disclosure. The horizontal axis of FIG. 24 represents intervals of time. There are three vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The waveforms shown in FIG. 24 are similar to those shown in FIG. 23, and hence are not discussed in further detail herein.

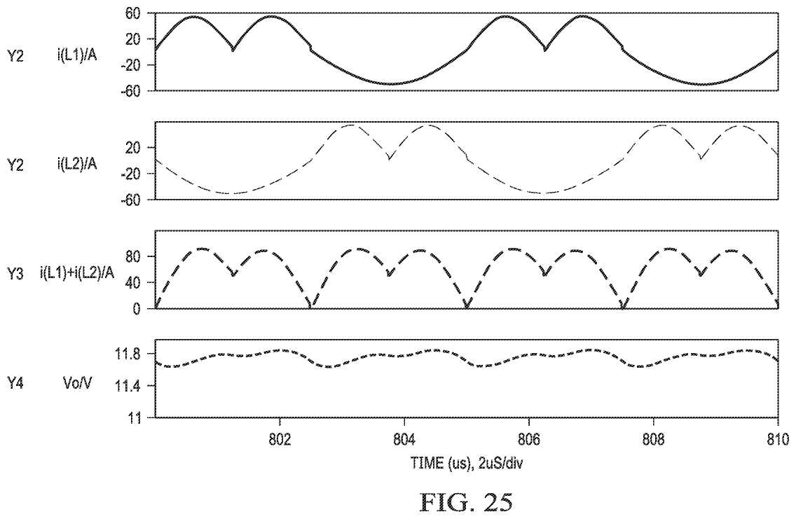

FIG. 25 illustrates three waveforms of the second switched-capacitor power conversion system operating in the third operating mode in accordance with various embodiments of the present disclosure. The horizontal axis of FIG. 25 represents intervals of time. There are four vertical axes. The first vertical axis Y1 represents the current flowing through the inductor L1. The second vertical axis Y2 represents the current flowing through the inductor L2. The third vertical axis Y3 represents the sum of the current flowing through the inductor L1 and the current flowing through the inductor L2. The four vertical axis Y4 the output voltage of the second switched-capacitor power conversion system.

The waveforms shown in FIG. 25 are obtained under the following operating conditions. The input voltage of the second switched-capacitor power conversion system 200 is equal to 48 V. The output voltage of the second switched-capacitor power conversion system 200 is equal to 12 V. The output power of the second switched-capacitor power conversion system 200 is equal to 800 W. The switching frequency of the first switched-capacitor power converter 102 is equal to 400 KHz. The switching frequency of the fourth switched-capacitor power converter 114 and the fifth switched-capacitor power converter 116 is equal to 200 KHz. The capacitance of the first flying capacitor C1 is equal to 40 uF. The capacitance of the second flying capacitor C2 is equal to 20 uF. The capacitance of the third flying capacitor C3 is equal to 20 uF. The inductance of the inductor L1 is equal to 33 nH. The inductance of the inductor L2 is equal to 33 nH.

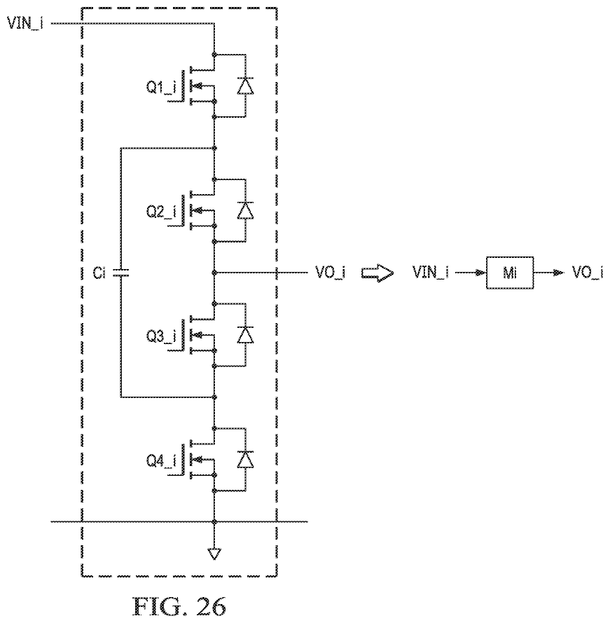

FIG. 26 illustrates a first power conversion unit of a multi-stage switched-capacitor power conversion system in accordance with various embodiments of the present disclosure. The first switched-capacitor power converter 102 shown in FIG. 2 is categorized as a first power conversion unit Mi, where i is equal to 1, 2, 3, . . . The first power conversion unit Mi comprises four switches Q1_i, Q2_i, Q3_i and Q4_i connected in series between an input voltage bus VIN_i and ground. A flying capacitor Ci is connected between a common node of switches Q1_i, Q2_i, and a common node of switches Q3_i, Q4_i. The output VO_i of the first power conversion unit Mi is connected to a common node of switches Q2_i and Q3_i. Throughout the description, the first power conversion unit Mi may be alternatively referred to as a power conversion unit Mi.

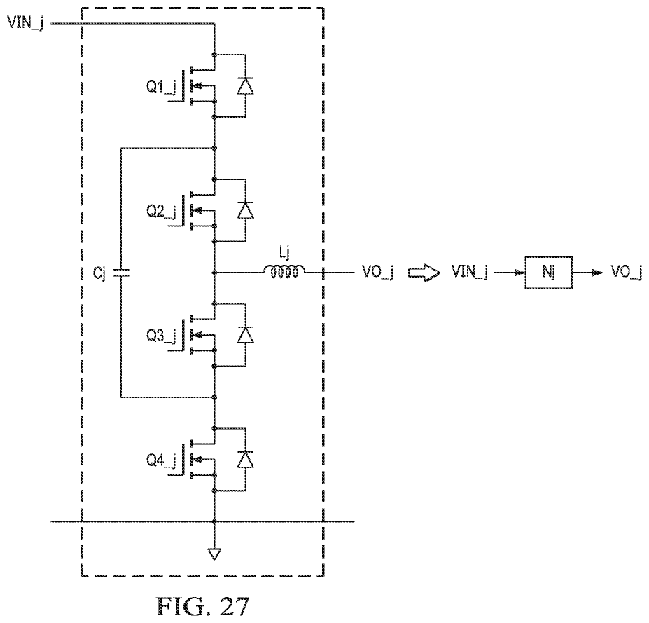

FIG. 27 illustrates a second power conversion unit of a multi-stage switched-capacitor power conversion system in accordance with various embodiments of the present disclosure. The second switched-capacitor power converter 104 shown in FIG. 2 and the third switched-capacitor power converter 106 shown in FIG. 3 are categorized as a second power conversion unit Nj, where j is equal to 1, 2, 3, . . . The second power conversion unit Nj comprises four switches Q1_j, Q2_j, Q3_j and Q4_j connected in series between an input voltage bus VIN_j and ground. A flying capacitor Cj is connected between a common node of switches Q1_j, Q2_j, and a common node of switches Q3_j, Q4_j. The output VO_j of the second power conversion unit Nj is connected to a common node of switches Q2_j and Q3_j through an inductor Lj. Throughout the description, the second power conversion unit Nj may be alternatively referred to as a power conversion unit Nj.

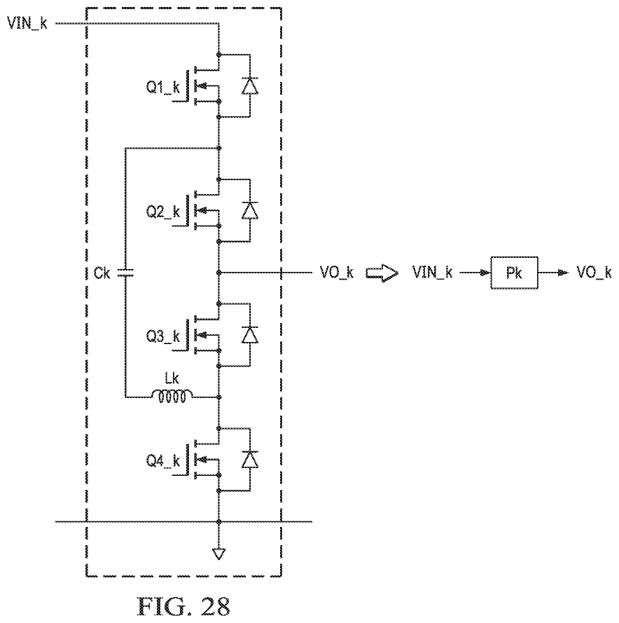

FIG. 28 illustrates a third power conversion unit of a multi-stage switched-capacitor power conversion system in accordance with various embodiments of the present disclosure. The fourth switched-capacitor power converter 114 shown in FIG. 20 and the fifth switched-capacitor power converter 116 shown in FIG. 21 are categorized as a third power conversion unit Pk, where k is equal to 1, 2, 3, . . . The third power conversion unit Pk comprises four switches Q1_k, Q2_k, Q3_k and Q4_k connected in series between an input voltage bus VIN_k and ground. A flying capacitor Ck and an inductor Lk are connected in series between a common node of switches Q1_k, Q2_k, and a common node of switches Q3_k, Q4_k. The output VO_k of the third power conversion unit Pk is connected to a common node of switches Q2_k and Q3_k. Throughout the description, the first power conversion unit Pk may be alternatively referred to as a power conversion unit Pk.

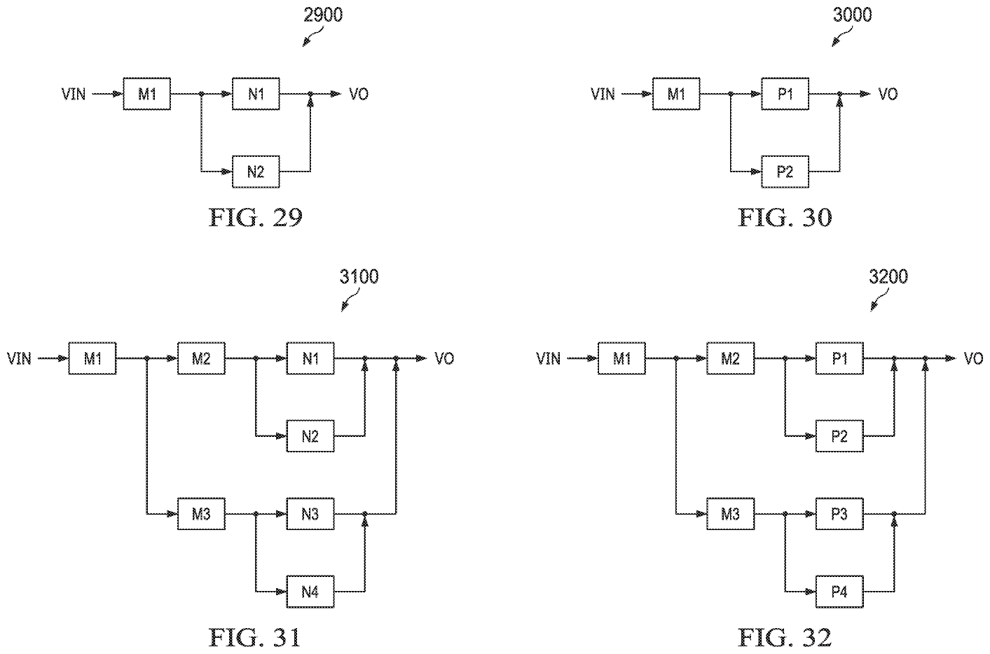

FIG. 29 illustrates a first two-stage switched-capacitor power conversion system in accordance with various embodiments of the present disclosure. The first two-stage switched-capacitor power conversion system 2900 comprises a first stage and a second stage connected in cascade between an input voltage VIN and an output voltage terminal VO. The first stage is implemented as a first power conversion unit M1. The second stage comprises a first power conversion unit N1 and a second power conversion unit N2 connected in parallel between an output of the first power conversion unit M1 and the output voltage terminal VO. The first two-stage switched-capacitor power conversion system 2900 is a 4:1 step-down power conversion system. The four operating modes described above are applicable to the first two-stage switched-capacitor power conversion system 2900.

FIG. 30 illustrates a second two-stage switched-capacitor power conversion system in accordance with various embodiments of the present disclosure. The second two-stage switched-capacitor power conversion system 3000 comprises a first stage and a second stage connected in cascade between an input voltage VIN and an output voltage terminal VO. The first stage is implemented as a first power conversion unit M1. The second stage comprises a first power conversion unit P1 and a second power conversion unit P2 connected in parallel between an output of the first power conversion unit M1 and the output voltage terminal VO. The second two-stage switched-capacitor power conversion system 3000 is a 4:1 step-down power conversion system. The four operating modes described above are applicable to the second two-stage switched-capacitor power conversion system 3000.

FIG. 31 illustrates a first three-stage switched-capacitor power conversion system in accordance with various embodiments of the present disclosure. The first three-stage switched-capacitor power conversion system 3100 comprises a first stage, a second stage and a third stage connected in cascade between an input voltage VIN and an output voltage terminal VO. The first stage is implemented as a first power conversion unit M1. The second stage comprises a second conversion unit M2 and a third power conversion unit M3. The inputs of the second conversion unit M2 and the third power conversion unit M3 are connected together and further connected to an output of the first power conversion unit M1.

The third stage comprises a first power conversion unit N1, a second power conversion unit N2, a third power conversion unit N3 and a fourth power conversion unit N4. The first power conversion unit N1 and the second power conversion unit N2 are connected in parallel between an output of the second power conversion unit M2 and the output voltage terminal VO. The third power conversion unit N3 and the fourth power conversion unit N4 are connected in parallel between an output of the second power conversion unit M2 and the output voltage terminal VO.

The first three-stage switched-capacitor power conversion system 3100 is an 8:1 step-down power conversion system. The four operating modes described above are applicable to the first three-stage switched-capacitor power conversion system 3100.

FIG. 32 illustrates a second three-stage switched-capacitor power conversion system in accordance with various embodiments of the present disclosure. The second three-stage switched-capacitor power conversion system 3200 comprises a first stage, a second stage and a third stage connected in cascade between an input voltage VIN and an output voltage terminal VO. The first stage is implemented as a first power conversion unit M1. The second stage comprises a second conversion unit M2 and a third power conversion unit M3. The inputs of the second conversion unit M2 and the third power conversion unit M3 are connected together and further connected to an output of the first power conversion unit M1.

The third stage comprises a first power conversion unit P1, a second power conversion unit P2, a third power conversion unit P3 and a fourth power conversion unit P4. The first power conversion unit P1 and the second power conversion unit P2 are connected in parallel between an output of the second power conversion unit M2 and the output voltage terminal VO. The third power conversion unit P3 and the fourth power conversion unit P4 are connected in parallel between an output of the second power conversion unit M2 and the output voltage terminal VO.

The second three-stage switched-capacitor power conversion system 3200 is an 8:1 step-down power conversion system. The four operating modes described above are applicable to the second three-stage switched-capacitor power conversion system 3200.

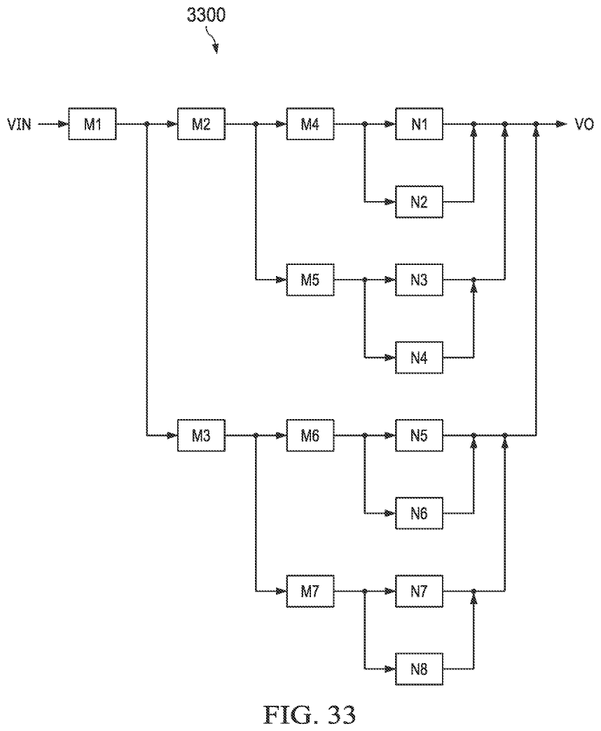

FIG. 33 illustrates a first four-stage switched-capacitor power conversion system in accordance with various embodiments of the present disclosure. The first four-stage switched-capacitor power conversion system 3300 comprises a first stage, a second stage, a third stage and a fourth stage connected in cascade between an input voltage VIN and an output voltage terminal VO. The first stage is implemented as a first power conversion unit M1. The second stage comprises a second conversion unit M2 and a third power conversion unit M3. The inputs of the second conversion unit M2 and the third power conversion unit M3 are connected together and further connected to an output of the first power conversion unit M1.

The third stage comprises a fourth power conversion unit M4, a fifth power conversion unit M5, a sixth power conversion unit M6 and a seventh power conversion unit M7. As shown in FIG. 33, the inputs of the fourth power conversion unit M4 and the fifth power conversion unit M5 are connected together and further connected to an output of the second power conversion unit M2. Likewise, the inputs of the sixth power conversion unit M6 and the seventh power conversion unit M7 are connected together and further connected to an output of the third power conversion unit M3.

The fourth stage comprises a first power conversion unit N1, a second power conversion unit N2, a third power conversion unit N3, a fourth power conversion unit N4, a fifth power conversion unit N5, a sixth power conversion unit N6, a seventh power conversion unit N7 and an eighth power conversion unit N8. As shown in FIG. 33, the first power conversion unit N1 and the second power conversion unit N2 are connected in parallel between an output of the fourth power conversion unit M4 and the output voltage terminal VO. The third power conversion unit N3 and the fourth power conversion unit N4 are connected in parallel between an output of the fifth power conversion unit M5 and the output voltage terminal VO. The fifth power conversion unit N5 and the sixth power conversion unit N6 are connected in parallel between an output of the sixth power conversion unit M6 and the output voltage terminal VO. The seventh power conversion unit N7 and the eighth power conversion unit N8 are connected in parallel between an output of the seventh power conversion unit M7 and the output voltage terminal VO.

The first four-stage switched-capacitor power conversion system 3300 is a 16:1 step-down power conversion system. The four operating modes described above are applicable to the first four-stage switched-capacitor power conversion system 3300.

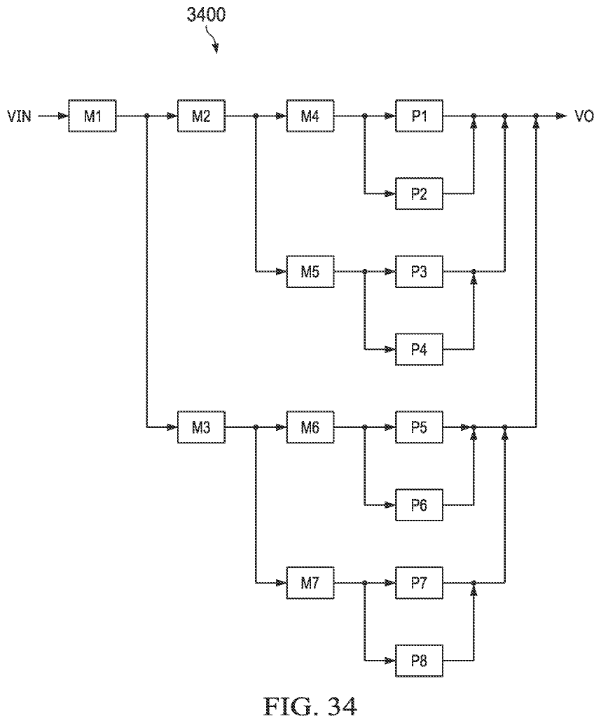

FIG. 34 illustrates a second four-stage switched-capacitor power conversion system in accordance with various embodiments of the present disclosure. The second four-stage switched-capacitor power conversion system 3400 comprises a first stage, a second stage, a third stage and a fourth stage connected in cascade between an input voltage VIN and an output voltage terminal VO. The first stage is implemented as a first power conversion unit M1. The second stage comprises a second conversion unit M2 and a third power conversion unit M3. The inputs of the second conversion unit M2 and the third power conversion unit M3 are connected together and further connected to an output of the first power conversion unit M1.

The third stage comprises a fourth power conversion unit M4, a fifth power conversion unit M5, a sixth power conversion unit M6 and a seventh power conversion unit M7. As shown in FIG. 34, the inputs of the fourth power conversion unit M4 and the fifth power conversion unit M5 are connected together and further connected to an output of the second power conversion unit M2. Likewise, the inputs of the sixth power conversion unit M6 and the seventh power conversion unit M7 are connected together and further connected to an output of the third power conversion unit M3.

The fourth stage comprises a first power conversion unit P1, a second power conversion unit P2, a third power conversion unit P3, a fourth power conversion unit P4, a fifth power conversion unit P5, a sixth power conversion unit P6, a seventh power conversion unit P7 and an eighth power conversion unit P8. As shown in FIG. 34, the first power conversion unit P1 and the second power conversion unit P2 are connected in parallel between an output of the fourth power conversion unit M4 and the output voltage terminal VO. The third power conversion unit P3 and the fourth power conversion unit P4 are connected in parallel between an output of the fifth power conversion unit M5 and the output voltage terminal VO. The fifth power conversion unit P5 and the sixth power conversion unit P6 are connected in parallel between an output of the sixth power conversion unit M6 and the output voltage terminal VO. The seventh power conversion unit P7 and the eighth power conversion unit P8 are connected in parallel between an output of the seventh power conversion unit M7 and the output voltage terminal VO.

The second four-stage switched-capacitor power conversion system 3400 is a 16:1 step-down power conversion system. The four operating modes described above are applicable to the second four-stage switched-capacitor power conversion system 3400.

It should be noted the multi-sage switched-capacitor power conversion systems shown FIGS. 29-34 are merely examples. A person skilled in the art would understand the structures shown FIGS. 29-34 may be extended further to any other suitable switched-capacitor power conversion systems such as a 32:1 step-down power conversion system.

It should further be noted that by swapping the input port and the output port shown in FIGS. 29-34, all the step-down switched-capacitor resonant converters proposed herein can be configured as step-up switched-capacitor resonant converters. Furthermore, the operating modes and the associated control methods above can also be adopted with slight modifications for use with the step-up switched-capacitor resonant converters.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. The specification and drawings are, accordingly, to be regarded simply as an illustration of the disclosure as defined by the appended claims, and are contemplated to cover any and all modifications, variations, combinations or equivalents that fall within the scope of the present disclosure.

1. A system comprising:
a first switched-capacitor converter including a plurality of switches connected in series;
a second switched-capacitor converter; and
a third switched-capacitor converter connected in parallel with the second switched-capacitor converter between a common node of two switches of the plurality of switches and a load, the second switched-capacitor converter and the third switched-capacitor converter both including inductors.

2. The system of claim 1, wherein the plurality of switches of the first switched-capacitor converter includes:
a first switch, a second switch, a third switch and a fourth switch connected in series between an input voltage bus and ground, and wherein the first switched-capacitor converter further includes a first flying capacitor connected between a common node of the first switch and the second switch, and a common node of the third switch and the fourth switch, the second switched-capacitor converter and the third switched-capacitor converter being connected in parallel between a common node of the second switch and the third switch, and the load.

3. The system of claim 1, wherein the second switched-capacitor converter includes:
a fifth switch, a sixth switch, a seventh switch and an eighth switch connected in series between an input voltage bus and ground, and wherein the second switched-capacitor converter further includes a second flying capacitor connected between a common node of the fifth switch and the sixth switch, and a common node of the seventh switch and the eighth switch, and a first inductor connected between a common node of the sixth switch and the seventh switch, and the load.

4. The system of claim 1, wherein the third switched-capacitor converter includes:
a ninth switch, a tenth switch, an eleventh switch and a twelfth switch connected in series between an input voltage bus and ground, and wherein the third switched-capacitor converter further includes a third flying capacitor connected between a common node of the ninth switch and the tenth switch, and a common node of the eleventh switch and the twelfth switch, and a second inductor connected between a common node of the tenth switch and the eleventh switch, and the load.

5. The system of claim 1, wherein the second switched-capacitor converter includes:
a fifth switch, a sixth switch, a seventh switch and an eighth switch connected in series between an input voltage bus and ground, and wherein the second switched-capacitor converter further includes a second flying capacitor and a first inductor connected in series between a common node of the fifth switch and the sixth switch, and a common node of the seventh switch and the eighth switch.

6. The system of claim 1, wherein the third switched-capacitor converter includes:
a ninth switch, a tenth switch, an eleventh switch and a twelfth switch connected in series between an input voltage bus and ground, and wherein the third switched-capacitor converter further includes a third flying capacitor and a second inductor connected in series between a common node of the ninth switch and the tenth switch, and a common node of the eleventh switch and the twelfth switch.

7. The system of claim 1, wherein the second switched-capacitor converter and the third switched-capacitor converter are configured to operate at 180 degrees out of phase from one another.

8. The system of claim 1, wherein each of the first switched-capacitor converter, the second switched-capacitor converter and the third switched-capacitor converter is configured as a 2:1 step-down power converter.

9. The system of claim 1, wherein switches of the first switched-capacitor converter, the second switched-capacitor converter and the third switched-capacitor converter are configured to operate at a duty cycle of approximately 50%.

10. The system of claim 1, wherein switches of the second switched-capacitor converter and the third switched-capacitor converter are configured to operate at a duty cycle greater than or equal to 50%, and switches of the first switched-capacitor converter are configured to operate at a duty cycle less than 50%.

11. A system comprising:
a plurality of switched-capacitor power conversion stages connected in cascade between a power source and a load, a first switched-capacitor power conversion stage of the plurality of switched-capacitor power conversion stages directly connected to the load, the first switched-capacitor power conversion stage including a plurality of first switched-capacitor power converters connected in parallel, each of which including an inductor, wherein a second switched-capacitor power conversion stage of the plurality of switched-capacitor power conversion stages is connected to the first switched-capacitor power conversion stage, the second switched-capacitor power conversion stage including a plurality of second switched-capacitor power converters, each of which connected to inputs of two parallel-connected first switched-capacitor power converters.

12. The system of claim 11, wherein the system is a two-stage switched-capacitor power conversion system.

13. The system of claim 12, wherein the second switched-capacitor power conversion stage includes a first switched-capacitor converter comprising a plurality of switches connected in series, and the first switched-capacitor power conversion stage includes a second switched-capacitor converter and a third switched-capacitor converter connected in parallel between the first switched-capacitor converter and the load.

14. The system of claim 13, wherein the first switched-capacitor converter includes:
a first switch, a second switch, a third switch and a fourth switch connected in series between an input voltage bus and ground; and
a first flying capacitor connected between a common node of the first switch and the second switch, and a common node of the third switch and the fourth switch, the second switched-capacitor converter and the third switched-capacitor converter connected in parallel between a common node of the second switch and the third switch and the load.

15. The system of claim 14, wherein the second switched-capacitor converter includes:
a fifth switch, a sixth switch, a seventh switch and an eighth switch connected in series between the common node of the second switch and the third switch, and ground;
a second flying capacitor connected between a common node of the fifth switch and the sixth switch, and a common node of the seventh switch and the eighth switch; and
a first inductor connected between a common node of the sixth switch and the seventh switch and the load.

16. The system of claim 13, wherein the first switched-capacitor converter includes:
a first switch, a second switch, a third switch and a fourth switch connected in series between an input voltage bus and ground; and
a first flying capacitor connected between a common node of the first switch and the second switch, and a common node of the third switch and the fourth switch, the second switched-capacitor converter and the third switched-capacitor converter connected in parallel between a common node of the second switch and the third switch and the load.

17. The system of claim 16, wherein the second switched-capacitor converter includes:
a fifth switch, a sixth switch, a seventh switch and an eighth switch connected in series between the common node of the second switch and the third switch, and ground; and
a second flying capacitor and a first inductor connected in series between a common node of the fifth switch and the sixth switch, and a common node of the seventh switch and the eighth switch.

18. A method comprising:
configuring a first switched-capacitor converter to operate at a first duty cycle; and
configuring a second switched-capacitor converter and a third switched-capacitor converter to operate at a second duty cycle, wherein the second switched-capacitor converter and the third switched-capacitor converter are connected in parallel and operate at 180 degrees out of phase from one another.

19. The method of claim 18, wherein:
the first switched-capacitor converter comprises:
a first switch, a second switch, a third switch and a fourth switch connected in series between an input voltage bus and ground; and
a first flying capacitor connected between a common node of the first switch and the second switch, and a common node of the third switch and the fourth switch, the second switched-capacitor converter and the third switched-capacitor converter connected in parallel between a common node of the second switch and the third switch and a load; and
the second switched-capacitor converter comprises:
a fifth switch, a sixth switch, a seventh switch and an eighth switch connected in series between the common node of the second switch and the third switch, and ground;
a second flying capacitor connected between a common node of the fifth switch and the sixth switch, and a common node of the seventh switch and the eighth switch; and
a first inductor connected between a common node of the sixth switch and the seventh switch and the load.

20. The method of claim 18, wherein:
the first switched-capacitor converter comprises:
a first switch, a second switch, a third switch and a fourth switch connected in series between an input voltage bus and ground; and
a first flying capacitor connected between a common node of the first switch and the second switch, and a common node of the third switch and the fourth switch, the second switched-capacitor converter and the third switched-capacitor converter connected in parallel between a common node of the second switch and the third switch and a load; and
the second switched-capacitor converter comprises:
a fifth switch, a sixth switch, a seventh switch and an eighth switch connected in series between the common node of the second switch and the third switch, and ground; and
a second flying capacitor and a first inductor connected in series between a common node of the fifth switch and the sixth switch, and a common node of the seventh switch and the eighth switch.
